(19) United States
(12) Patent Application Publication
(10) Pub. No.: US 2024/0310912 A1
(43) Pub. Date: Sep. 19, 2024

(54) Soft Wireless Headband Bioelectronics and Electrooculography for Persistent Human-Machine Interfaces

(71) Applicant: Georgia Tech Research Corporation, Atlanta, GA (US)

(72) Inventor: Woon-Hong Yeo, Atlanta, GA (US)

(21) Appl. No.: 18/585,954

(22) Filed: Feb. 23, 2024

Related U.S. Application Data
(60) Provisional application No. 63/486,816, filed on Feb. 24, 2023.

(51) Int. Cl. G06F 3/01; G05B 15/02; G05D 1/223; H01B 5/14

(52) U.S. Cl. CPC G06F 3/015; G05B 15/02; G05D 1/2234; H01B 5/14

(57) ABSTRACT

An exemplary system includes a set of electrooculogram (EOG) sensors, each including an array of flexible electrodes fabricated on a flexible-circuit substrate, the flexible-circuit substrate operatively connected to an analog-to-digital converter circuitry operatively connected to a wireless interface circuitry; and a brain-machine interface operatively connected to the set of EOG sensors, the brain-machine interface including: a processor; and a memory operatively connected to the processor, the memory having instructions stored thereon, wherein execution of the instructions by the processor causes the processor to: receive EOG signals acquired from the EOG sensors; continuously classify brain signals as control signals via a trained neural network from the acquired EOG signals; and output the control signals.

### RELATED APPLICATION

This application claims priority to, and the benefit of, U.S. Provisional Patent Application No. 63/486,816, filed Feb. 24, 2023, entitled “SOFT WIRELESS HEADBAND BIOELECTRONICS AND ELECTROOCULOGRAPHY FOR PERSISTENT HUMAN-MACHINE INTERFACES,” which is incorporated by reference herein in its entirety.

### BACKGROUND

Electrooculograms (EOG) include measurements of electrical potentials between the front and rear of the human eye. These electrical potentials can be used for evaluating the health of an eye, or detecting diseases or other conditions of the eye. EOG measurements can measure an eye's position based on a potential difference between electrodes placed around the eye (e.g., above and below, left and right, etc.).

HMI (Human machine interface) systems include ways that humans interact with machines. Touch screens computer mice, keyboards, switches, levers, are examples of HMI that are commonly used, and often operated by hand. Many types of HMI require physical hand movements to operate the HMI systems.

There are benefits to the improvements of HMI interfaces and EOG measurements.

### SUMMARY

An exemplary system and method are disclosed that employ AI-based controller with EOG signals acquired via a wearable EOG system for persistent human-machine interface (HMI). In some embodiments, the wearable EOG system includes a low-profile, headband-type, soft wearable electronics, embedded stretchable electrodes, and a flexible wireless circuit. The headband may employ dry electrodes (e.g., nanomembrane electrodes) for persistent contact with the skin. The Al-based controller can classify, via the EOG signals, eye motions, e.g., blink, up, down, left, and right, as input for control operation. A study was conducted showed an Al-based controller using convolutional neural network can achieve 98.3% accuracy for a set of ocular movements. HMI systems described herein can be used for healthcare systems (e.g., alarms, medication dispensers, etc.), communication systems (e.g., typing or sending a message), consumer electronics (controlling a game or software application), and prosthetics (e.g., controlling the emotion of a prosthetic limb).

In some aspects, the embodiments described herein relate to a system including: a set of electrooculogram (EOG) sensors, each including an array of flexible electrodes fabricated on a flexible-circuit substrate, the flexible-circuit substrate operatively connected to an analog-to-digital converter circuitry operatively connected to a wireless interface circuitry; and a brain-machine interface operatively connected to the set of EOG sensors, the brain-machine interface including: a processor; and a memory operatively connected to the processor, the memory having instructions stored thereon, wherein execution of the instructions by the processor causes the processor to: receive EOG signals acquired from the EOG sensors; continuously classify brain signals as control signals via a trained neural network from the acquired EOG signals; and output the control signals.

In some aspects, the embodiments described herein relate to a system, wherein the EOG sensor is a low-profile EOG sensor.

In some aspects, the embodiments described herein relate to a system, wherein each array of flexible electrodes includes fractal patterned electrodes.

In some aspects, the embodiments described herein relate to a system, wherein the fractal patterned electrodes include a plurality of curved electrodes.

In some aspects, the embodiments described herein relate to a system, wherein each array of flexible electrodes includes electrodes patterned in an open-mesh.

In some aspects, the embodiments described herein relate to a system, wherein the array of flexible electrodes include a polyimide sheet, a CR layer, and an AU layer.

In some aspects, the embodiments described herein relate to a system, wherein the wireless interface circuitry includes a flexible circuit.

In some aspects, the techniques described herein relate to a system, further including a headband, wherein the flexible-circuit substrate is coupled to the headband and the headband is configured to dispose the set of EOG sensors on a skin surface of a wearer.

In some aspects, the embodiments described herein relate to a system, wherein the headband includes flexible thermoplastic.

In some aspects, the embodiments described herein relate to a system, wherein the control signals are configured to control a vehicle.

In some aspects, the embodiments described herein relate to a system, wherein the control signals are configured to control a healthcare system (e.g. an alarm, medication dispenser, etc.).

In some aspects, the embodiments described herein relate to a system, wherein the trained neural network includes a convolutional neural network (CNN) classifier.

In some aspects, the embodiments described herein relate to a system, wherein the electrodes include nanomembrane electrodes.

In some aspects, the embodiments described herein relate to a system, wherein the electrodes include dry gold electrodes.

In some aspects, the techniques described herein relate to a method including: providing a set of EOG sensors placed at a scalp of a user, wherein each EOG sensor of the set of EOG sensors includes an array of flexible electrodes fabricated on a flexible circuit substrate, the flexible circuit substrate operatively connected to an analog-to-digital converter circuitry operatively coupled to a wireless interface circuitry; and receiving, by a processor or a brain-machine interface operatively connected to the set of EOG sensors, EOG signals acquired from the EOG sensor continuously classifying, by the processor, brain signals as control signals via a trained neural network from the acquired EOG signals; and outputting, by the processor, the control signals.

In some aspects, the embodiments described herein relate to a method, wherein the method further includes controlling a vehicle based on the control signals.

In some aspects, the embodiments described herein relate to a method, wherein the trained neural network includes a CNN classifier.

In some aspects, the embodiments described herein relate to a non-transitory computer-readable medium having instructions stored thereon, wherein execution of the instructions by a processor of a brain-machine interface controller causes the processor to: receive EOG signals from a set of EOG sensors placed at a scalp of a user, wherein each EOG sensor of the set of EOG sensors includes an array of flexible electrodes fabricated on a flexible circuit substrate, the flexible circuit substrate operatively connected to an analog-to-digital converter circuitry operatively coupled to a wireless interface circuitry; continuously classify brain signals as control signals via a trained neural network from the EOG signals; and output the control signals.

In some aspects, the embodiments described herein relate to a computer-readable medium, further including instructions to control a vehicle based on the control signals.

In some aspects, the embodiments described herein relate to a computer-readable medium, wherein the trained neural network includes a CNN classifier.

### BRIEF DESCRIPTION OF THE DRAWINGS

The skilled person in the art will understand that the drawings described below are for illustration purposes only.

FIG. 1A shows an example electrooculogram-based (EOG) brain-machine-interface system in accordance with an illustrative embodiment.

FIGS. 1B and 1C show benefits of a dry electrode for an electrooculogram-based (EOG) brain-machine-interface system. FIG. 1B shows an example comparison of EOG signals detected by a gel electrode compared to dry gold electrodes, in accordance with an illustrative embodiment. FIG. 1C shows the benefits of the dry electrode for reducing skin irritation, including an example comparison of EOG skin rash after removal of the gel electrode from the skin compared to no adverse event for the skin with the dry electrode, continuous mounting of the dry one on the skin for multiple hours.

FIG. 1D shows an example EOG system including a headband, flexible wireless circuit, and an array of nanomembrane electrodes.

FIG. 1E shows an example EOG brain-machine interface system using two channel electrodes and fractal patterned gold electrodes on soft fabric, in accordance with an illustrative embodiment.

FIG. 1F shows an exploded view of a headband, in accordance with an illustrative embodiment.

FIGS. 2A and 2B show an example electrode and fabrication process for manufacturing the electrode. FIG. 2A shows an example cross section of an electrode that can be used for EOG measurements, in accordance with an illustrative embodiment.

FIG. 2B illustrates a fabrication process of a gold electrode using polymer coating, thin film deposition, and laser cutting, in accordance with an illustrative embodiment.

FIG. 3 shows an example method of generating control signals for an HMI system using an EOG sensor, in accordance with an illustrative embodiment.

FIGS. 4A-4D show experimental results from a study conducted to develop HMI using EOG sensor. FIG. 4A illustrates a computational study of mechanical behavior of an electrode with stretching and bending, in accordance with an illustrative embodiment. FIG. 4B illustrates an example validation of an electrode's reliability with stretching and bending, in accordance with an illustrative embodiment. FIG. 4C illustrates resistance measurements of an example electrode quantifying the electrode's reliability and showing negligible changes during stretching and bending. FIG. 4D illustrates an example of skin biocompatibility for a gel electrode and a gold electrode, showing that the gel electrode causes skin irritation and elevates skin temperature when compared to the gold electrode.

FIGS. 5A and 5B illustrate examples of signal processing of EOG signals from wearable devices. FIG. 5A illustrates an example of a step-by-step signal for processing measured EOG signals from a wearable device, in accordance with an illustrative embodiment.

FIG. 5B illustrates raw EOG signals and corresponding eye movements including left, right, up and down motions, in accordance with an illustrative embodiment.

FIGS. 6A and 6B illustrate example machine learning models that can be used for signal classification. FIG. 6A illustrates an example kNN classifier that can be used for data classification, in accordance with an illustrative embodiment. FIG. 6B illustrates a flowchart showing a spatial CNN model with filters of decreasing size, flattening, and a Dense-Softmax output, in accordance with an illustrative embodiment.

FIG. 6C shows a comparison of data classification results with three different confusion matrices, for a signal processing outcome, kNN algorithm, and CNN algorithm, in accordance with an illustrative embodiment.

FIG. 7A illustrates a subject controlling a vehicle using an example embodiment of the present disclosure.

FIG. 7B illustrates an example of vehicle control outputs based on eye movements sensed and classified using an EOG system, in accordance with an illustrative embodiment.

FIG. 7C illustrates an example of steering a vehicle based on control outputs illustrated in FIG. 7B, in accordance with an illustrative embodiment.

FIGS. 8A and 8B illustrate comparisons of EOG devices and signal processing methods, according to embodiments of the present disclosure FIG. 8A illustrates a comparison of EOG devices and Human Machine Interface Applications. FIG. 8B illustrates a comparison of confusion matrices from signal processing, kNN and CNN algorithms, in accordance with an illustrative embodiment.

FIGS. 9A and 9B illustrate an example headband and experimental setup for testing EOG recorded by a headband, according to embodiments of the present disclosure. FIG. 9A illustrates headband platforms, in accordance with illustrative embodiments. FIG. 9B illustrates an experimental setup for EOG sensitivity testing using a series of marked targets, in accordance with an illustrative embodiment.

FIG. 10 illustrates impedance measurement with gel electrodes and dry gold electrodes, in accordance with an illustrative embodiment.

FIGS. 11A and 11B illustrate hardware that can be used to implement EOG systems and devices according to embodiments of the present disclosure. FIG. 11A illustrates function chips used in a flexible wireless circuit, in accordance with an illustrative embodiment.

FIG. 11B illustrates batteries and charging circuits, in accordance with an illustrative embodiment.

FIG. 12 illustrates a finite element analysis (FEA) simulation, in accordance with an illustrative embodiment.

FIGS. 13A-13E illustrate experimental results for embodiments of the present disclosure. FIG. 13A illustrates tensile testing and bending testing of a gold fractal electrode, in accordance with an illustrative embodiment. FIG. 13B illustrates example locations for dry gold electrodes on a subject's face, in accordance with an illustrative embodiment. FIG. 13C illustrates raw EOG 2 channel data and a classified result, in accordance with an illustrative embodiment. FIG. 13D illustrates real-time, continuous monitoring of EOG with a wearable device, in accordance with an illustrative embodiment. FIG. 13E illustrates a demonstration of wireless real-time control of a mini-drone car with the wearable device, in accordance with an illustrative embodiment.

### DETAILED SPECIFICATION

Some references, which may include various patents, patent applications, and publications, are cited in a reference list and discussed in the disclosure provided herein. The citation and/or discussion of such references is provided merely to clarify the description of the disclosed technology and is not an admission that any such reference is “prior art” to any aspects of the disclosed technology described herein. In terms of notation, “[n]” corresponds to the nth reference in the list. For example, [1] refers to the first reference in the list. All references cited and discussed in this specification are incorporated herein by reference in their entireties and to the same extent as if each reference was individually incorporated by reference.

### Example System

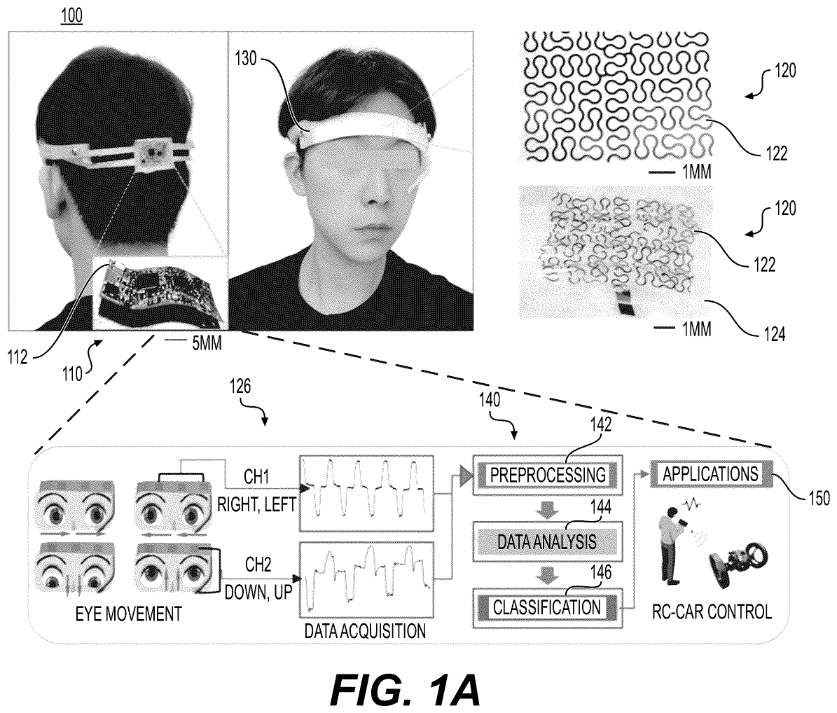

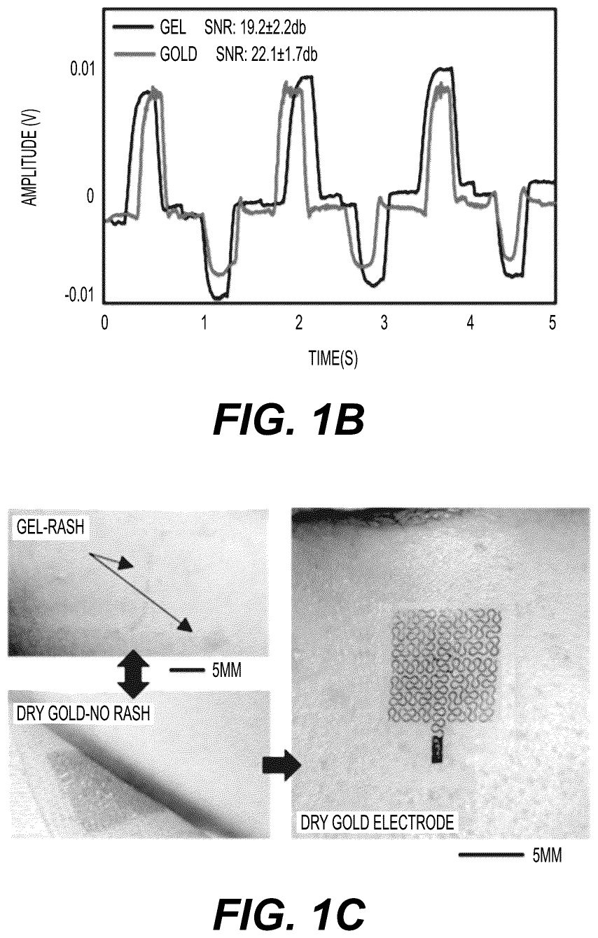

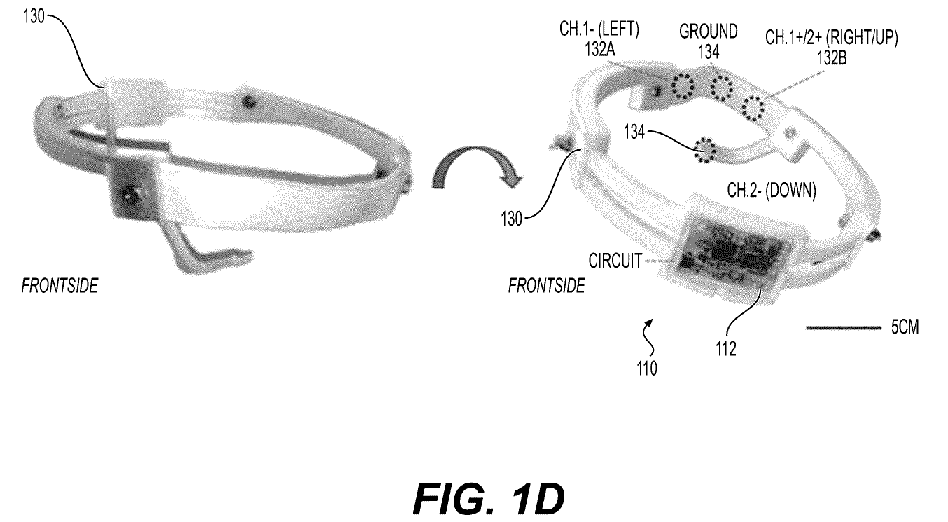

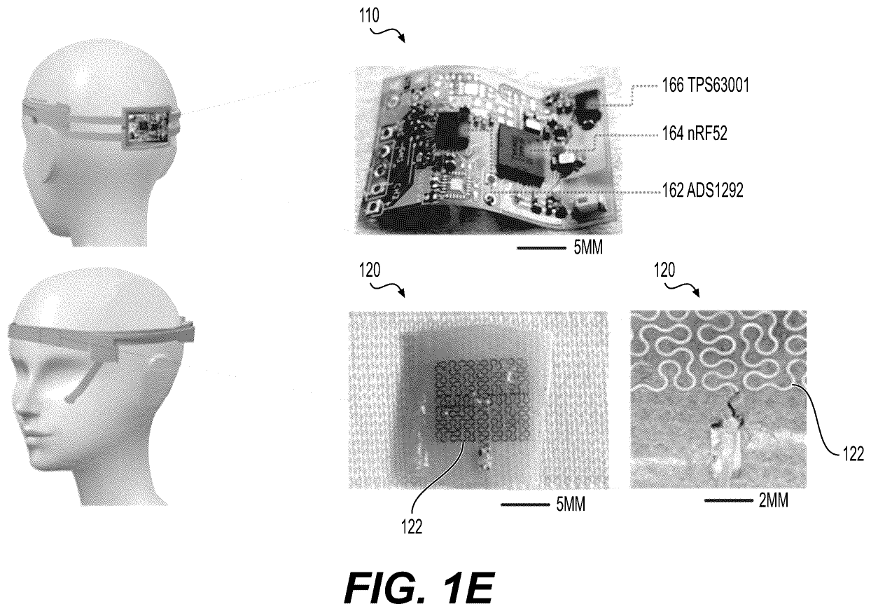

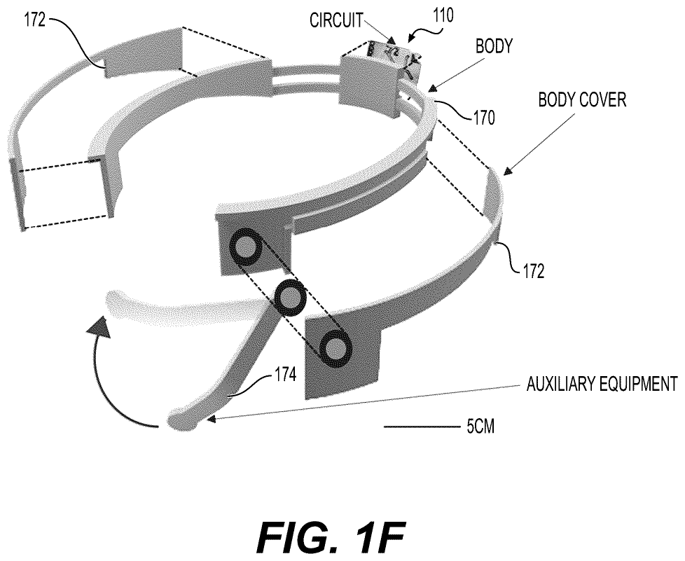

With reference to FIG. 1A, an example system 100 includes a brain machine interface 110 configured to output control signals based on EOG signals measured by EOG sensors 120. The EOG sensors 120 can include an array of flexible electrodes 122 formed on a flexible circuit substrate 124. As shown in FIG. 1, the EOG sensors 120 can optionally be configured as low-profile EOG sensors that are configured to sit on the surface of the skin. The array of flexible electrodes 122 can optionally include nanomembrane electrodes.

The brain machine interface 110 can be coupled to the EOG sensors 120. The brain machine interface 110 can include a processor and a memory configured to process a waveform 126 from the EOG sensors 120.

A flowchart 140 illustrates example processing operations that can be performed. Pre-processing 142 can include performing analog-to-digital conversion of the waveform 126. The analog-to-digital conversion can be performed by analog-to-digital converter circuitry that is optionally part of the brain machine interface.

Data analysis 144 can also be optionally be performed by the brain machine interface 110. Data analysis can optionally include detrend functions, filtering (e.g. bandpass filtering), and adjustment of a DC-offset in the waveform 126.

Example waveform classification. Classification 146 can include classifying the waveform 126 or part of the waveform 126 as a type of eye motion. Non-limiting examples of eye motion that can be classified include classifying the eye motion by direction the eyes are moving (e.g., left, right, up, down), and/or detecting that the eye is open, closed, or blinking.

In embodiments of the present disclosure where the eye motions are classified as control signals, the brain machine interface 110 can be configured to output the control signal or signals. Optionally, the brain machine interface 110 can include a wireless interface configured to transmit the control signals to a computing device configured to be controlled by the control signals, and/or to a network.

Optionally, classification 146 can include using a trained neural network to classify the waveform 126. The classification 146 can be performed before or after the steps of data analysis 144 and pre-processing 142. Optionally, the neural network is a neural network including a convolutional neural network (CNN) classifier.

Optionally, the type of eye motion classified in the classification 146 step can map to (e.g., correspond to) a control signal.

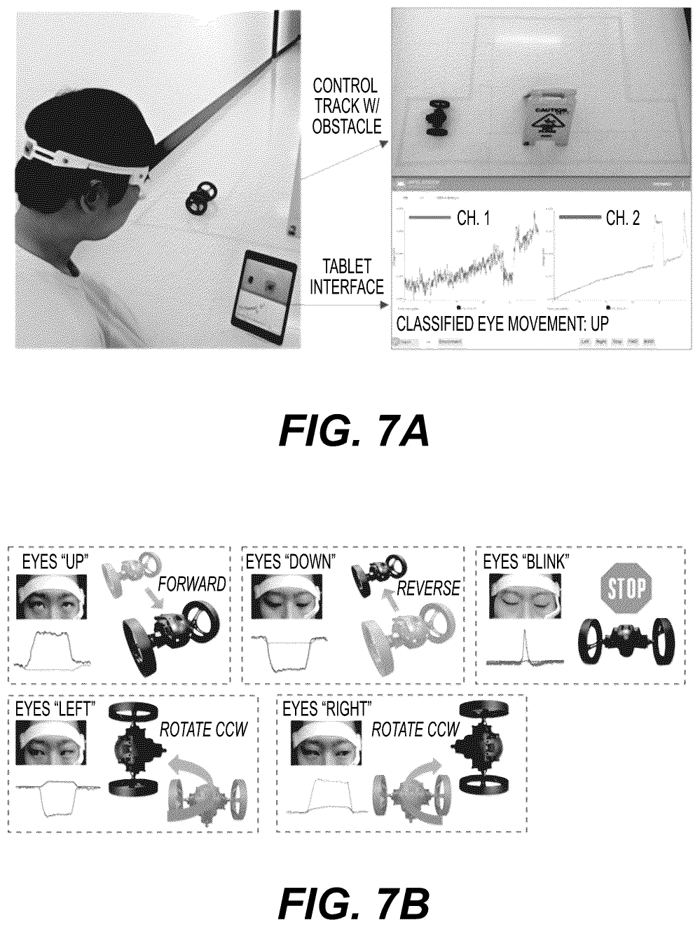

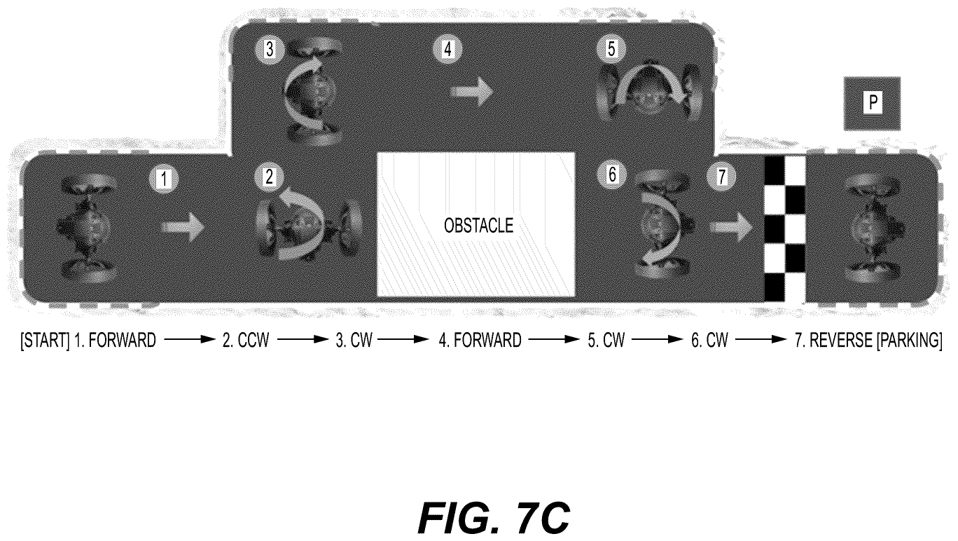

In some embodiments, classification 146 can include classifying the eye motion as a control signal. For example, the controls of a vehicle can be mapped to eye motion so that an up motion corresponds to a control signal causing the vehicle to move forward, a down motion corresponds to a control signal causing the vehicle to move in reverse, a blink motion corresponds to a control signal causing the vehicle to stop, a left motion corresponds to a control signal causing the vehicle to rotate left, and a right motion corresponds to a control signal causing the vehicle to rotate right. Additional examples of a control scheme for a vehicle and mappings of eye motions to control signals, are described with reference to the study of the example embodiment herein, for example with reference to FIGS. 7A-7C. It should be understood that any mapping of eye motions or EOG signals to control signals can be performed, and that the example mappings provided herein are intended only as non-limiting examples. Additionally, it should be understood that, while example embodiments illustrate the use of EOG to control a remote control vehicle (e.g., FIGS. 7A-7C), the control signals can be used for any type of vehicle, including cars, planes, wheelchairs, boats, etc.

The control signals can be used for any purpose, and the control of vehicles is intended only as a non-limiting example. Additional non-limiting examples of systems that can be controlled using embodiments of the present disclosure include healthcare systems (e.g., alarms, medication dispensers, etc.), communication systems (e.g., typing or sending a message), consumer electronics (controlling a game or software application), and prosthetics (e.g., controlling the emotion of a prosthetic limb).

The systems and methods described herein improve various control systems for different types of users. As described herein, existing forms of eye tracking can require infrared sensors and cameras that block the vision of a wearer. Existing forms of EOG often use gel electrodes that irritate the skin and are not practical for prolonged use. Embodiments of the present disclosure therefore improve control systems using eye tracking by providing eye tracking without cameras that also minimize skin irritation.

Example Flexible Electrodes. Still with reference to FIG. 1A, the array of flexible electrodes can be formed in a fractal pattern, referred to herein as “fractal patterned electrodes.” While an example fractal pattern is shown herein, it should be understood that other fractal structures can be used in embodiments of the present disclosure. The present disclosure also contemplates the use of non-fractal patterns of electrodes, (e.g., repeating serpentine shapes). Both fractal shapes and various serpentine shapes, as an open pattern, can be configured to be stretchable, allowing for stretchable and flexible electrodes. Additionally, both fractal pattern and non-fractal pattern electrodes can include sets of curved electrodes. Alternatively or additionally, the array of flexible electrodes can be formed as an “open mesh” pattern as shown in FIG. 1A.

The human machine interface 110 can optionally be formed as a flexible circuit 112 in some embodiments of the present disclosure. Alternatively or additionally, the wireless interface circuitry can be formed as a flexible circuit 112 or on a flexible circuit 112. It should be understood that the human machine interface 110 and the wireless interface circuitry can be formed on the same and/or different flexible circuits in various embodiments of the present disclosure, and that in some embodiments of the present disclosure one of the human machine interface 110 and wireless interface circuit are formed on a flexible circuit, while the other is not.

With reference to FIGS. 1B and 1C, embodiments of the present disclosure include dry gold electrodes with superior amplitude vs. time performance to gel electrodes, as shown in FIG. 1B. As shown in FIG. 1C, an example dry gold electrode 155 can minimize or prevent skin rash formed by gel electrodes.

Example headband. FIG. 1D illustrates a headband 130 according to embodiments of the present disclosure including exemplary locations for electrodes. The headband 130 includes a human machine interface 110 and flexible circuit 112, as described with reference to FIG. 1A. Electrodes (e.g., the arrays of flexible electrodes 122 described in FIG. 1A) can be located at different locations on the headband 130 to contact different locations on a wearer's skin. In the exemplary embodiment shown in FIG. 1D, two channels are used (“Ch.1” and “Ch.2”). The headband 130 can optionally be configured with a first electrode location 132a for the Ch.1 negative signal, a second electrode location 132b corresponding to the Ch.1 and Ch.2 positive signal, a third electrode location 132d corresponding to the Ch.2 negative signal, a ground location 134 for an electrical ground. In the embodiment shown in FIG. 1D, the Ch. 1-signal corresponds to a “left” signal, the Ch.2-corresponds to a “down” signal, the Ch.1+ corresponds to a “right” signal, and the Ch.2+ corresponds to an “up” signal. It should be understood that the electrode locations, ground and mapping of signals to electrode locations shown in FIG. 1D are intended only as non-limiting examples, and that different numbers of electrodes, electrode positions, and/or mappings of electrodes to signals are contemplated by the present disclosure.

With reference to FIG. 1A, embodiments of the present disclosure optionally include a headband 130. The headband 130 can optionally be formed of a flexible plastic (e.g., a flexible thermoplastic).

The headband 130 can optionally be coupled to a the flexible circuit substrate 124 that the electrodes 122 are formed on. As shown in FIG. 1A, the headband 130 can position the electrodes 122 on a wearer's head so that they contact a wearer's skin and can measure EOG signals from the wearer's eyes.

FIG. 1E illustrates an example embodiment of a headband including a human machine interface 110 formed on a flexible circuit 112. The human machine interface 110 includes a Bluetooth circuit 164, an analog to digital conversion circuit 162, and a power converter circuit 166. It should be understood that these components are only non-limiting examples, and that the human machine interface 110 and/or flexible circuit 112 can include additional or different components to the components illustrated in FIG. 1E.

FIG. 1F illustrates an exploded view of the headband 130 shown in FIGS. 1A and 1E. As shown in FIG. 1F, the headband 130 can optionally be formed with body covers 172, body 170 and auxiliary equipment 174. The number and arrangement of body covers 172, body 170, and auxiliary equipment 174 are intended only as non-limiting examples.

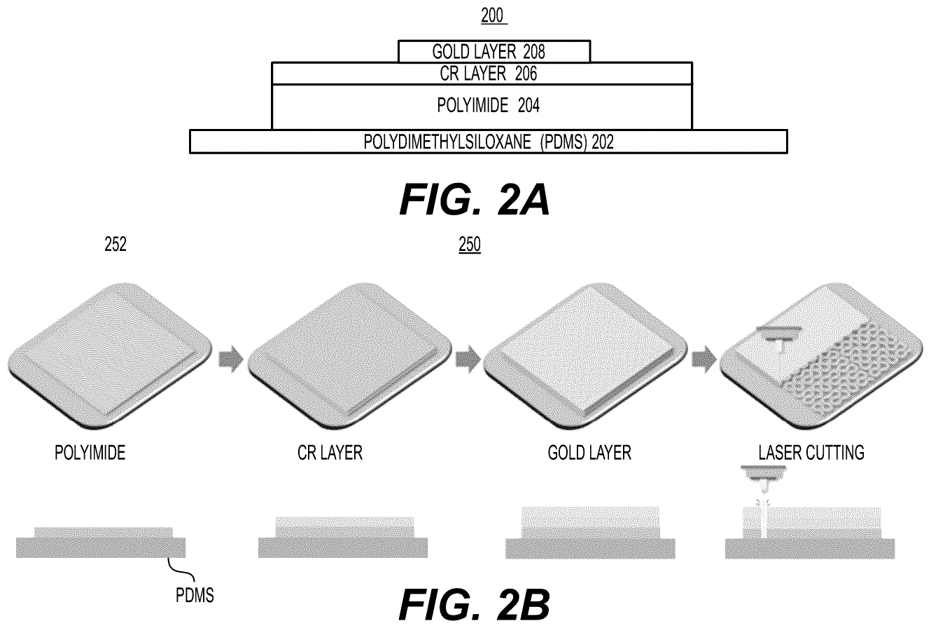

Example Flexible Electrode. FIG. 2A illustrates an example cross section of a flexible electrode 200, according to embodiments of the present disclosure. The flexible electrode 200 is fabricated on a polydimethylsiloxane (PDMS) substrate 202 that provides a flexible moisture resistant structure. A layer of polyimide 204 can be formed on the PDMS substrate 202. The polyimide 204 can include metal layers formed opposite the PDMS substrate 202. In the example embodiment shown in FIG. 2A, the metal layers are a CR layer 206 and a gold layer 208. The PDMS substrate 202, polyimide 204, Cr layer 2-6, and/or gold layer 208 can be machined to form electrodes with different shapes. Optionally, laser cutting is configured to cut through the polyimide 204, CR layer 206 and gold layer 208. FIG. 2B shows an example method of manufacturing flexible electrodes, including the flexible electrode 200. A polyimide layer can be deposited at step 252 onto a PDMS substrate 202. The polyimide layer 204 can be metallized at step 254 with a Cr layer, and at step 256 with a gold layer. Laser cutting at step 258 can then form electrodes by removing layers deposited at steps 252, 254, and 256. Any pattern of electrodes can be formed by laser cutting. Non-limiting examples of electrode patterns that can be formed include fractal electrodes, non-fractal electrodes, repeating patterns of electrodes, serpentine electrodes, and various curved and non-curved electrode shapes.

### Example Method

With reference to FIG. 3, embodiments of the present disclosure include methods and computer implemented methods for classifying signals from electrodes as control signals (e.g., using the systems and electrodes described with reference to FIGS. 1A-2B.

At step 310 the method includes providing a set of EOG sensors placed at a scalp of a user.

Optionally, as described with reference to FIGS. 1A-1E, the EOG sensors can include an array of flexible electrodes fabricated on a flexible circuit substrate. The flexible circuit substrate can be operatively connected to an analog-to-digital converter circuitry operatively coupled to a wireless interface circuitry.

At step 320, the method includes receiving, by a processor or a brain-machine interface operatively connected to the set of EOG sensors, EOG signals acquired from the EOG sensor

At step 330, the method includes continuously classifying, by the processor, brain signals as control signals via a trained neural network from the acquired EOG signals. As described with reference to FIG. 1A, embodiments of the present disclosure include CNN classifier neural networks.

At step 340 the method includes outputting, by the processor, the control signals. As described with reference to FIG. 1A, the control signals can include signals configured to control a vehicle or any other system, and the control signals can be output by the wireless interface circuitry described with reference to FIG. 1A.

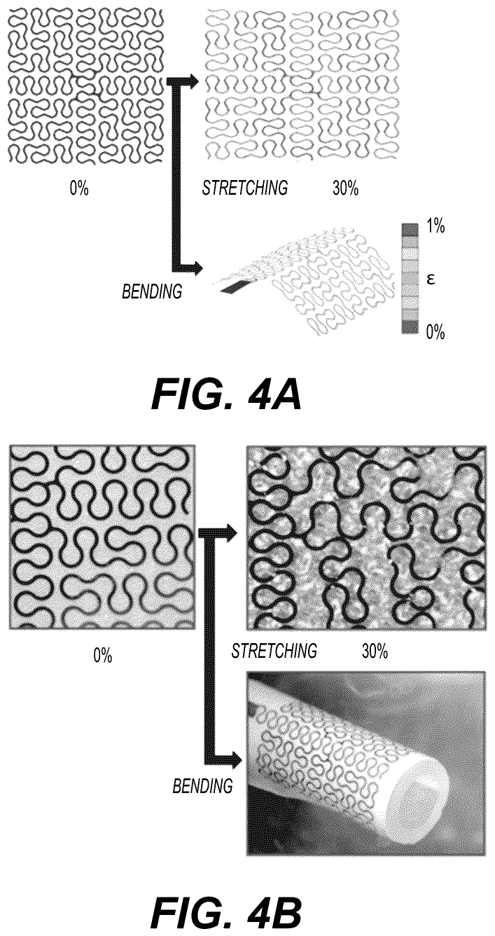

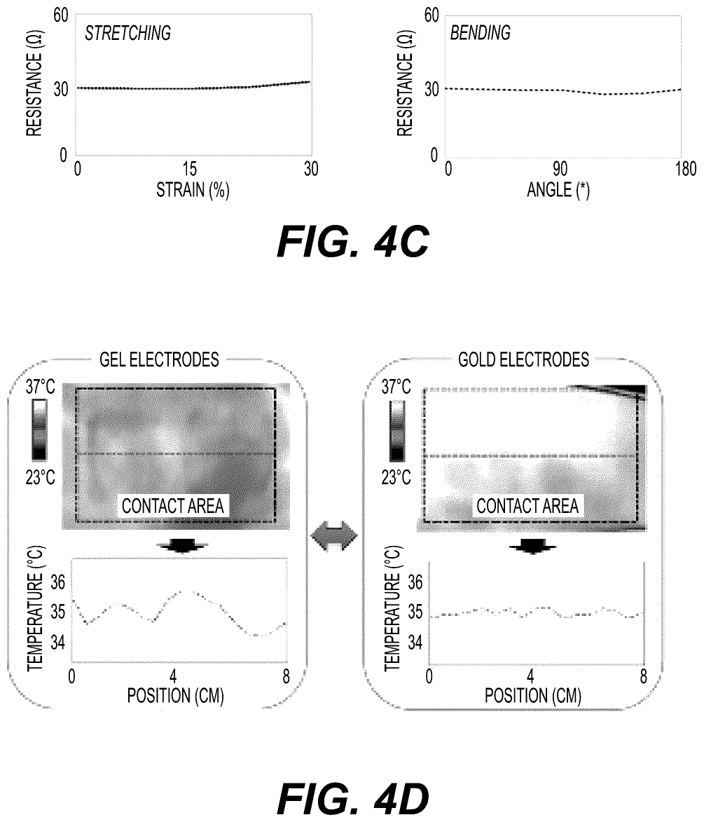

It should also be understood that the steps of method 300 and the other methods described with reference to FIGS. 1A-3, as well as the study of the example embodiments described with reference to FIGS. 4A-20, can be implemented as non-transitory computer-readable media.

### Experimental Results and Additional Examples

A study was conducted to develop and evaluate a brain-machine interfaces. The study employed EOG and flexible electrodes.

Advances in wearable technologies enable improvements in systems for people to interact with external devices, known as human-machine interfaces (HMI). Among them, electrooculograms (EOG) measured by wearable devices are used for eye movement-enabled HMI. Existing systems of EOG recording commonly use gel electrodes for recording EOG signals. However, the gel is problematic due to skin irritation, while separate bulky electronics cause motion artifacts. Embodiments of the present disclosure include improvements to electrodes that can be used for EOG recording and/or other HMI interfaces.

A study was performed using an example embodiment of the present disclosure including a low-profile, headband-type, soft wearable electronic system with embedded stretchable electrodes and a flexible wireless circuit to detect EOG signals for persistent HMI. The headband with dry electrodes was printed with flexible thermoplastic polyurethane. Nanomembrane electrodes were prepared by thin film deposition and laser cutting techniques. A set of signal processing data from dry electrodes demonstrated successful real-time classification of cye motions, including blink, up, down, left, and right. The study showed that the convolutional neural network performs exceptionally well compared to other machine learning methods, showing 98.3% accuracy with six classes: the highest performance to date in EOG classification with only four electrodes. Collectively, the real-time demonstration of continuous wireless control of a 2-wheeled radio-controlled car showed the potential of the bioelectronic system and the algorithm for targeting various HMI and virtual reality applications.

HMI technologies can be used to connect healthcare applications. For example, a touch screen and joystick are HMI, a user interface connecting a person to a machine. [1]. A wheelchair based on HMI can aid disabled people in their daily activities [2], [3], [4], [5]. Input signals for HMI can be body motions such as hand or finger motion and biopotential. Healthcare applications can require an ergonomic approach and high-precision. [6]. In this case, biopotential signals can be attractive candidates since biopotential is non-invasive, requires minimal hardware, and contains user movement information. Physiological biopotentials, such as electromyography (EMG), electroencephalography (EEG), and electrooculography (EOG), can be the control commands. For example, EMG signals from muscle movements with a fast response have can connect with HMI [7].

However, in cases where the muscles are weak (e.g., due to a disability) the muscles may not be able to produce the required stimulus for the detection of EMG [8]. EEG can be another way, which exploits neural information as input control for HMI. However, noninvasive EEG features may not contain sufficient information about small movements [9]. High-fidelity EEG can also be difficult to acquire and not feasible for real-time and accurate HMI applications. When measured from the scalp, an EEG signal has an amplitude between about 10 μV to 100 uV. But EOG amplitude, which has an amplitude between about 0.05 mV to 3 mV, is larger than EEG amplitude [10], [11], [12], [13]. Frail grip strength and issues with controlling their bodies for existing motorized wheelchair users [14], [15], [16], [17], [18], can further limit the use of EMG and EEG in those populations. EOG can track eye movements by measuring the potential via the positively charged cornea and negatively charged retina as another form of HMI with fewer drawbacks than EMG and EEG [19].

Wearable EOG devices in the form of glasses named JINS MEME have one electrode on the bridge of the nose and one on each of the nose pads of the eyeglasses [5], [20]. Studies also manufactured 3D Printed glasses-type wearable EOG devices [21]. However, a glasses-type device is inconvenient to people who are already wearing glasses. These devices are restricted when the electrode is secured to the skin or when there is movement. In addition, glasses-type platforms can be challenging to wear for people with a variety of head sizes because glasses-type platforms are made with a fixed frame width and temple length. Also, wearing EOG glasses on an inappropriate head size can cause the glasses-type platform to come off during active movements.

From the perspective of electrodes, studies using gel electrodes show high-fidelity recording. But gel electrodes have limitations, such as poor breathability, skin irritation, and loss of performance during long-term monitoring due to drying. Gel electrodes dehydrate and reduce electrode performance over time [22]. For the aforementioned reasons, the gel electrodes should be changed periodically. Constant changing of electrodes is not convenient in healthcare applications and is inefficient [23]. On the other hand, prior work demonstrated HMI using eye-tracking capability within wearable devices by integrating infrared cameras [24]. This HMI using eye-tracking has several problems. Eye tracking using infrared cameras also can require a camera that blocks that person's view. This system also requires clear pupil and eye images of the user. Still, eyelashes and eyelids can hinder the successful detection of the pupil and bright light can also interfere with pupil detection [25].

The example embodiments of the present disclosure described herein can include a soft material-based, all-in-one headband EOG device integrating a flexible wireless circuit and an array of fractal gold electrodes. The headband platform can include a size-adjustability and stable adhesion. In the case of a glasses-type platform, the part that supports the face is narrow, but the headband type platform can have a wider electrode-skin contact area, so multiple electrodes can be secured to the face. To address gel issues such as skin irritation and short-term durability, embodiments of the present disclosure include ultrathin, dry electrodes. Mesh-patterned gold electrodes can have biocompatibility and processibility to measure biopotentials [26], [27]. An example embodiment includes an ultrathin, fractal-designed gold electrode that can help the electrode accommodate dynamic skin deformation for a high-fidelity recording of EOG and causes fewer skin irritations compared to the existing gel electrodes. Also, the wearable EOG device can acquire EOG data and classify eye directions in real-time. The example device shows high accuracy in classifying six different classes with four electrodes. Overall, embodiments of the present disclosure can meet requirements such as ergonomic designs and/or high-precision interfaces. The wearable EOG device with this system allows users to acquire EOG signals stably and control various healthcare applications including controlling medical systems (e.g., alarms, medication dispensers, etc.).

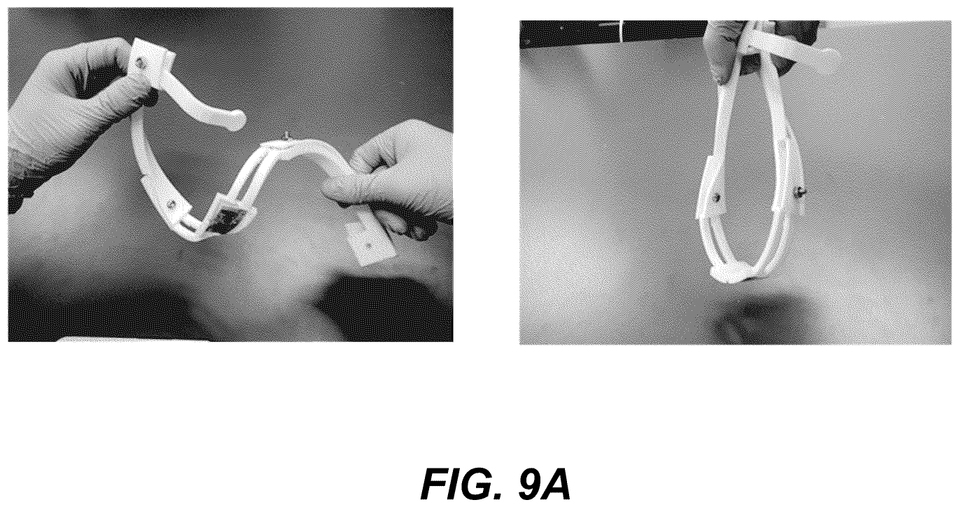

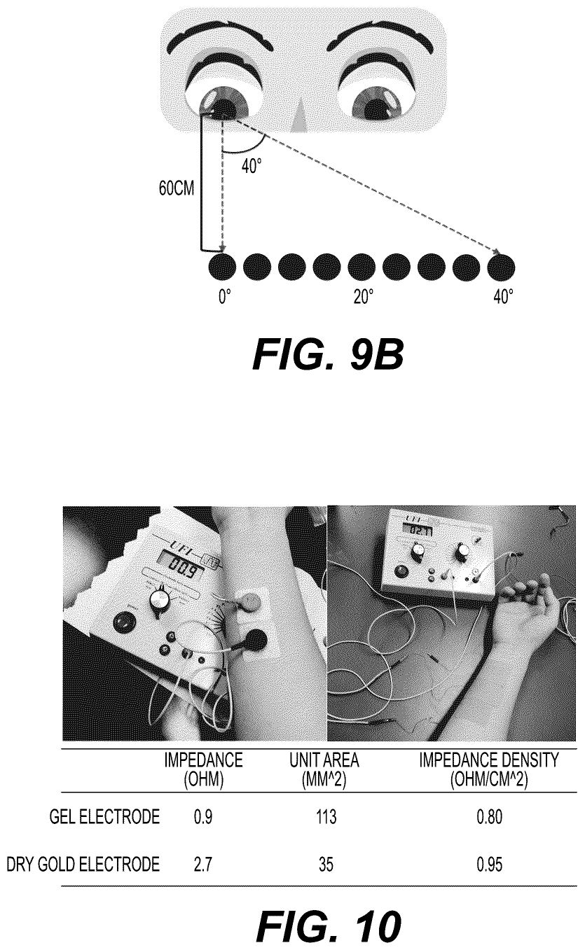

FIGS. 1A-1D summarizes an overview of an example integrated bioelectronic system according to the present disclosure. The example integrated bioelectronic system was used in the study for detecting eye movements and persistent HMI. A portable and wearable EOG system enables real-time, continuous, and long-term recording of EOG signals to classify eye movements. FIG. 1A shows a subject wearing the headband-type EOG device, integrated with the flexible circuit and fractal gold electrodes. The example embodiment selected the electrode locations to fit the headband-type platform. [28-30]. Two electrodes were positioned 1 cm above each eye. One electrode was placed 1 cm below the left lower eyelid for vertical eye movement. A common grounding electrode was placed on the middle of the forehead [29]. The 3D-printed wearable EOG device is composed of a tension string for securing electrodes to the subject's face. To accommodate various head sizes, thermoplastic polyurethane (TPU), a flexible rubber-like material, makes the headset platform. FIG. 9A shows the flexibility of the headband platform. A dry nanomembrane electrode has a stretchable fractal pattern as described with reference to FIGS. 1A-1F. Embodiments of the present disclosure can provide maximized stretchability and bending capability without mechanical fracture. The graph in FIG. 1B shows EOG signals for left and right eye movements, recorded by two types of electrodes. Then, calculated SNR compares the performance of the dry gold electrode with the conventional gel electrode [31]. In the experiment, two electrodes detected changes in EOG amplitudes according to angles of eye direction. The electrodes were positioned 1 cm away from each eye for concurrent comparison. Sensitivity measurements are performed by tracing a series of marked targets, located 60 cm away from the eyes (FIG. 9B) [14]. The gold electrode's sensitivity is 12.3±0.5 μV/° and the conventional gel electrode's sensitivity is 11.7±0.9 μV/°. The result in FIG. 1B shows that the gold electrode (SNR: 22.1±1.7 dB) has a slightly higher SNR than the commercial electrode (SNR: 19.2±2.2 dB), capturing the performance of the dry electrode for high-quality EOG detection. FIG. 9B illustrates a comparison of the skin-electrode contact impedance between a conventional gel electrode and the example dry electrode, showing comparable values in the impedance density. In addition, the study compared to the gel electrode causing skin irritation, the dry gold electrode shows excellent skin compatibility while having intimate contact with the skin as shown in FIG. 1C. An example process that uses EOG signals from eye movements for various applications is shown in FIG. 1A. With two electrode channels, the example embodiment studied herein can measure EOG data that is preprocessed, filtered, and classified. FIG. 1A also shows an example of an RC car control via EOG, demonstrated in this work.

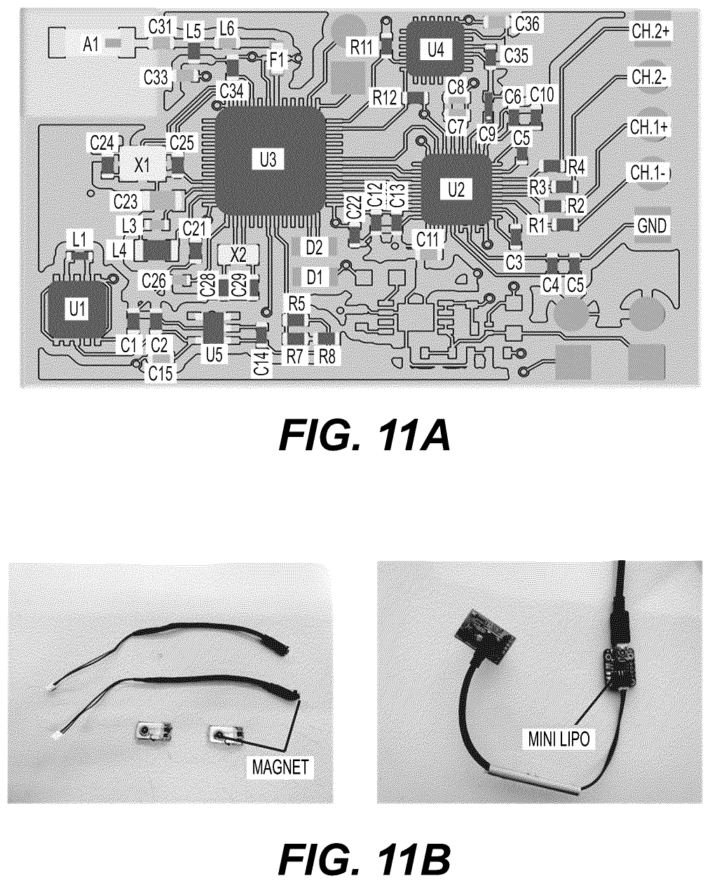

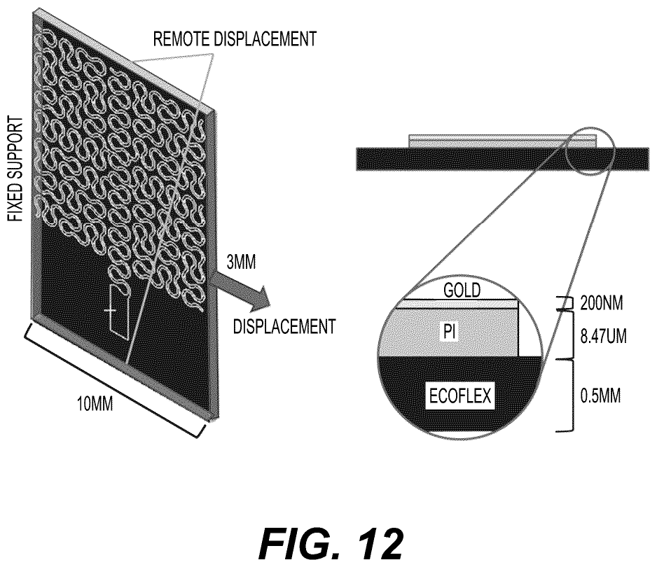

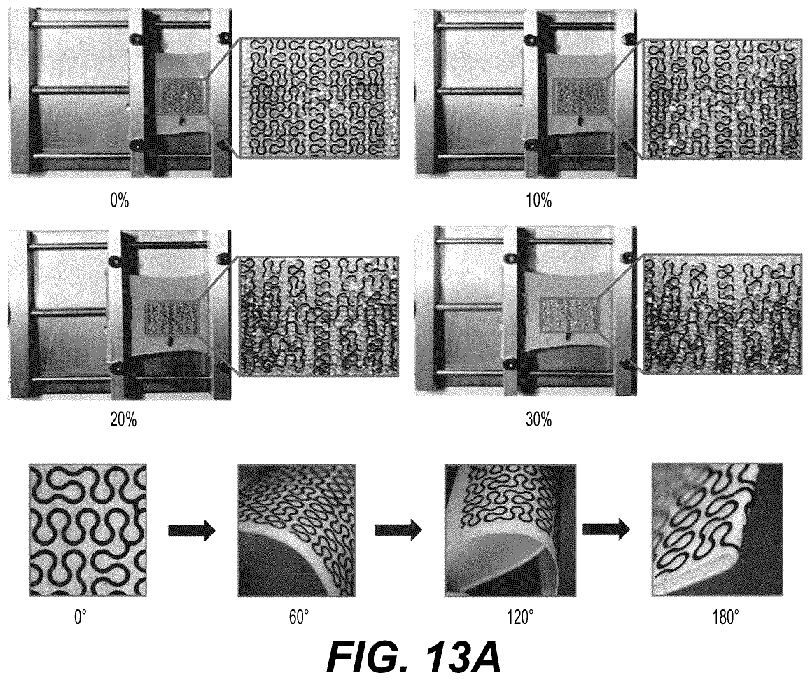

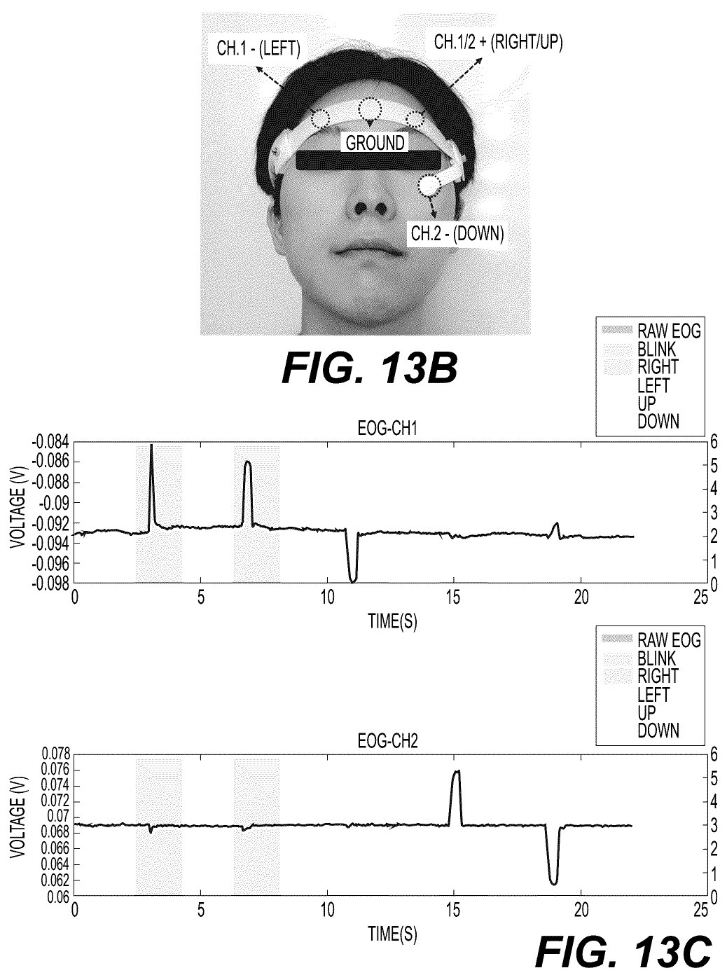

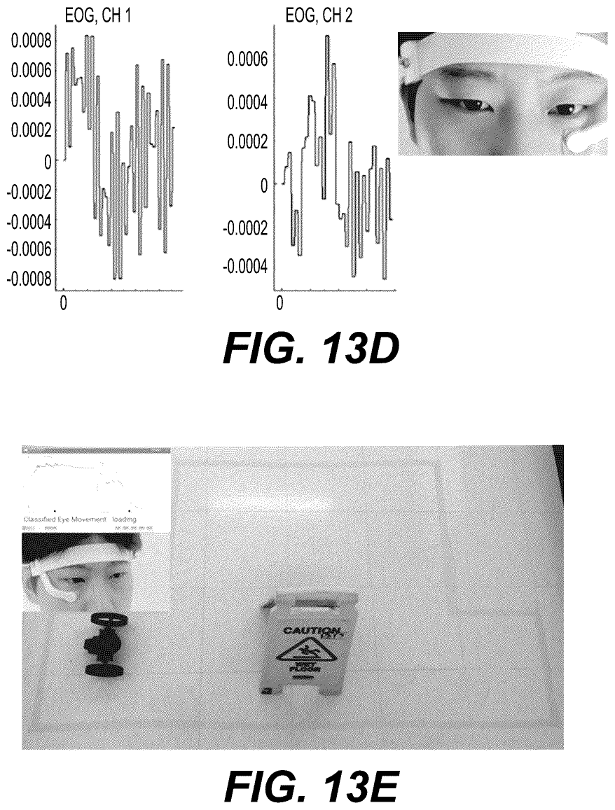

Fabrication and characterization of a wearable EOG device system. Recent wearable devices use hard-soft materials integration, nanomanufacturing, and chip packaging technologies [32], [33], [34]. The example embodiment combines thin-film metallization, laser manufacturing, 3D printing, and system integration to develop a fully integrated all-in-one wearable EOG platform. The base structure uses TPU made by 3D printing, which includes a set of nanomembrane electrodes and a flexible wireless circuit (FIG. 1D). A subject can easily wear the headband device with a size-adjustable mechanism (FIG. 1E). For wireless signal detection, the system includes a low-profile, flexible circuit having a Bluetooth-low-energy chip and other chip components (as illustrated in FIGS. 1E and 13). Time-varying EOG signals are captured by the fractal gold electrodes at 250 Hz and transmitted to the front analog-to-digital converter (ADS1292). Next, to receive sensor data and regulate circuit operation with a built-in microprocessor, the multiprotocol system-on-chip module (nRF52832), which can process and transmit data over 2.4 GHz, is used via the built-in microprocessor. For multiple uses of the wearable device, the flexible circuit contains a rechargeable lithium-polymer battery, charging magnets, and a switch (FIG. 11B). In addition, the headband system includes a set of fractal gold electrodes that are transfer-printed to the adhesive side of the medical patch (9907T) using a water-soluble tape (FIG. 1E) [22], [35]. A flexible thin-film cable connects the electrodes with the circuit (FIG. 1E). The gold electrodes used in the study were fabricated by following multiple manufacturing steps using a coating of a polymer (polyimide) on a soft PDMS substrate, metallization of Cr and Au, and laser micromachining to create stretchable patterns (FIG. 2B).

Characterization of mechanical behavior and compatibility of the membrane electrodes. The mechanical reliability of stretchable electrodes maintains the skin-contact quality during real-time continuous EOG detection. Therefore, the study conducted a set of computational studies using FEA, considering cyclic stretching and bending situations when an electrode is mounted on the skin. FIG. 4A shows the FEA results of an electrode, showing that the maximum principal strain applied to Au is less than 1% under the tensile and bending strain. The fractal-patterned design was used to manufacture electrodes, and the study validated the mechanical reliability (FIG. 4B). A microscopic investigation observes mechanical fractures before and after stretching and bending tests, showing no visual damage. In this test, the maximum tensile strain was applied up to 30%, and the bending angle was 180° with a radius of curvature: 6 mm. A 30% strain was chosen based on estimates that a human's exterior epithelial tissue can be stretched up to 20% without damage [36], and normal skin deformations do not exceed the selected bending curvature [37]. The visual observation of mechanical fracture was further validated by measuring electrical resistance. FIG. 4C shows the negligible resistance changes during the electrode's stretching and bending. The study further investigated the skin biocompatibility of a gel electrode and a dry gold electrode using infrared thermography (FIG. 4D). While the dry electrode shows no side effects after 8 hours of wearing, the gel electrode causes skin irritation and temperature elevation after 4 hours. When using the gel electrode, adhesive pads mounting the rigid electrode to the skin remove dead skin cells from the epidermis, causing skin rashes.

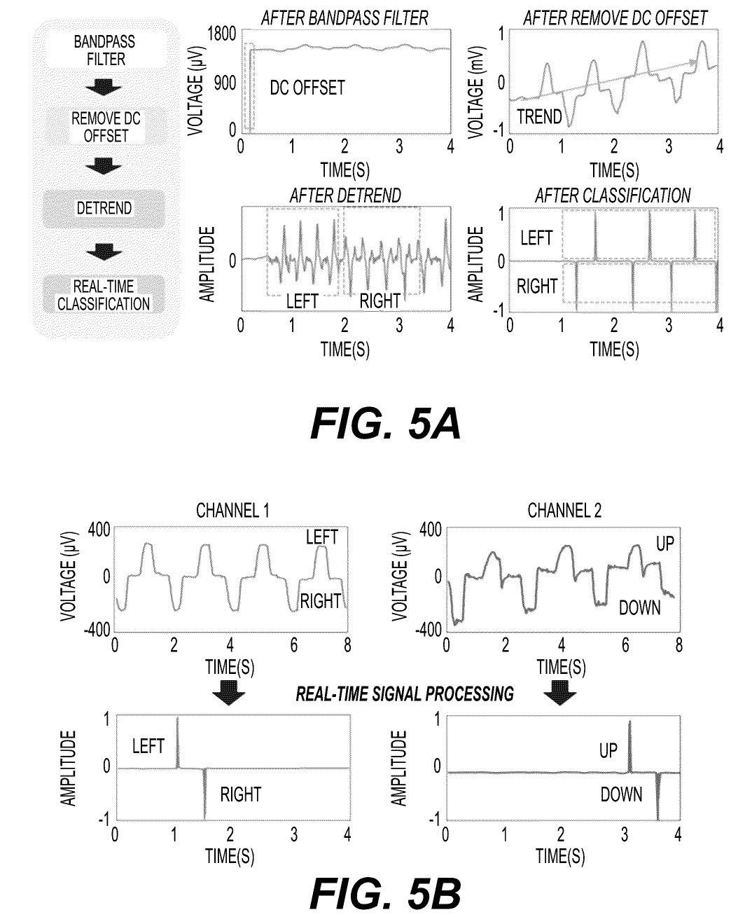

Optimization of real-time classification via signal processing and feature extraction. A flow chart in FIG. 5A shows an example sequence of processing of measured EOG signals from the example wearable device; four corresponding graphs on the right show examples of processed signals after each step, including bandpass filter, DC offset, detrend, and classification. In this process, the EOG raw data was received by a Python program through Bluetooth. Since EOG data mainly contain low frequencies (sampling rate: 250 Hz), a 3rd-order Butterworth finite impulse response filter (FIR) is used to remove noise [38]. FIR is a bandpass filter widely used in digital signal processing, showing an excellent linear phase character [39]. To remove DC offset, the first offset value was removed from others. As a result, measured signals can show trends that are not intrinsic to the data. To eliminate this trend, detrend function was used. Lastly, filtered data from three different steps was classified by evaluating the magnitude. The classified data is converted into a signal with a size of 1, and the direction of the eye is classified according to the code. A set of representative EOG signals in FIG. 5A shows raw data from four different eye movements. Among them, the horizontal direction of the eyes was channel 1, and the vertical direction of the eyes was channel 2. After signal processing, these signals was classified as left, right, up, and down motions (FIG. 5C). FIG. 13D illustrates an example illustration of a real-time, continuous monitoring of EOG with a wearable device.

Development and comparison of machine learning algorithms for data classification. Prior studies show the limitation of signal processing when detecting more than five classes [28]; with six classes, the accuracy was only 91.25%. According to other studies, a kNN algorithm is more efficient when classifying EOG signals than decision tree and support vector machine methods [40], [41]. The kNN classification uses the nearest distance metric and the neighbor's number k value. When one of the parameters is varying, another parameter is fixed [41], [42].

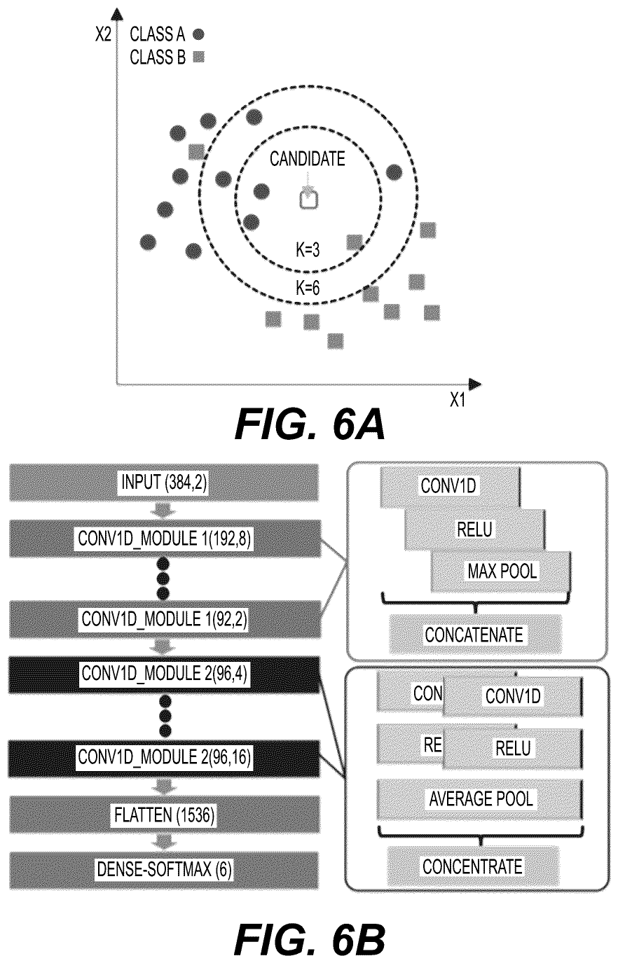

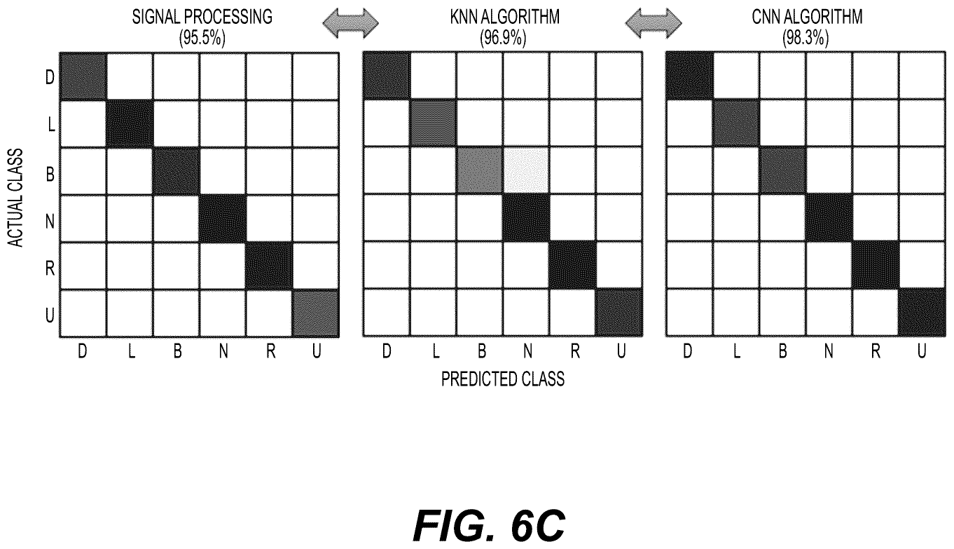

In this kNN algorithm, testing data was classified by finding the greatest number, with the closest relative distance to neighbors; each neighbor belongs to a specific class. FIG. 6A shows an example of a kNN classification where the test candidate is classified as either blue squares or red circles. If k=3, the candidate is assigned to the red circles (2 red circles>1 blue square). If k=6, the candidate is again assigned to the red circles (5 red circles>1 blue square).

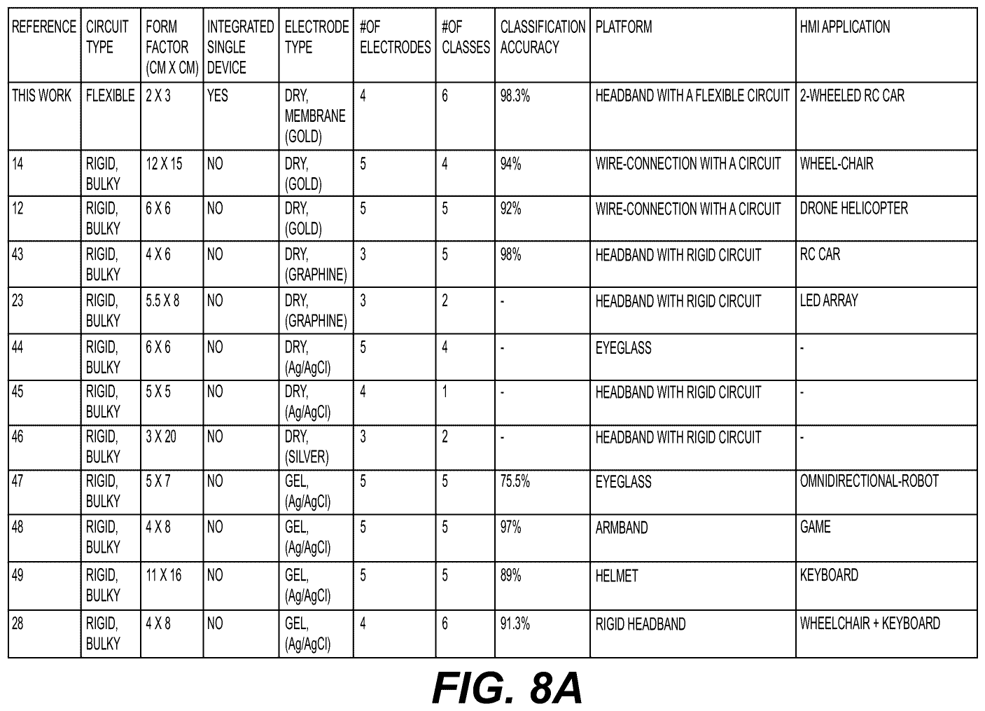

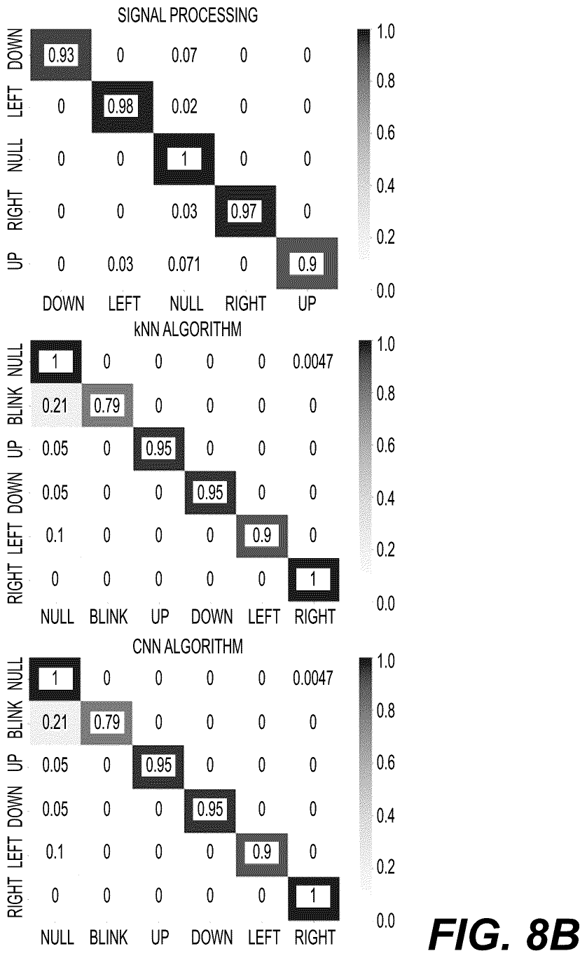

The study used a CNN classifier to compare the performance of machine learning algorithms. FIG. 6B illustrates the details of an embodiment of the CNN classification processes. The CNN model featuring layers of one-dimensional convolutions included two kinds of modules. Then, this model was followed by filters of flattening and a Dense-Softmax output. In this study, EOG data collected by the wearable device is split into the training set (75%) and the test set (25%). The preprocessed data was transferred to either the kNN or the CNN classifier. Then, the test dataset is analyzed by comparing the training dataset. Each model predicts the test results and shows the results through the confusion matrixes. FIG. 6C summarizes and compares the performance of signal processing and two machine learning methods. The study used multiple eye movements, including up (U), down (D), left (L), right (R), blink (B), and null (N). The signal processing method with 6 classes showed an accuracy of 95.5%. Compared to that, kNN and CNN methods with 6 classes show higher accuracies, 96.9% and 98.3%, respectively. FIG. 8B illustrates confusion matrixes from signal processing, kNN, and CNN algorithms including accuracies of each class. Overall, the CNN classification result showed the highest accuracy among reported articles that detect EOG signals. Also, it takes less than a second from pre-processing to Real-time classification. FIG. 8A captures the advantages of the example wearable system and superior classification performance compared to prior studies. FIG. 8A also shows that the example wearable system is compact and flexible by comparing previous EOG devices based on the size and type of circuits.

Demonstration of wireless real-time control of a RC car with the wearable device. The study herein demonstrates an example of persistent wireless HMI using the headband wearable device and EOG signals, as shown in FIGS. 7A-7C. Multiple eye movements, detected by sensors, can successfully control a 2-wheeled RC car by accurately following the designated pathway and avoiding an obstacle. FIG. 7A illustrates a subject who wears an example sensor-integrated headband, a tablet capturing the real-time EOG signals, and a 2-wheeled RC car to control. FIG. 7B, illustrates a control track with an obstacle that the car follows and a view of an Android app for displaying EOG signals and real-time classification outcomes. In the example shown in FIG. 7B, there are five different control commands, including up, down, blink, left (CCW; counter-clockwise), and right (CW; clockwise) motions (FIG. 7C). Considering an emergency case during operation, the blink command immediately stops the car when unintended eye movements are classified. The 2-wheeled RC car follows eye movements of a subject who wears the device, which moves the car from the starting position to the parking location. Seven consecutive commands are delivered to the car, including 1) go forward, 2) CCW rotation and go forward, 3) CW rotation, 4) go forward, 5) CW rotation and go forward, 6) CW rotation, and 7) go reverse to park.

The results described herein show the effectiveness of persistent HMI using EOG signals for control. The wearable headband platform offers a firm contact of stretchable electrodes with the skin, which also can be worn by different users with various head sizes. The example manufacturing process including metal deposition and laser cutting, fabricates an array of thin-film dry electrodes without needing conductive gels for high-quality EOG recording. The highly stretchable and flexible electrode shows reliability in cyclic mechanical tests while demonstrating excellent skin compatibility over eight hours. The fractal-patterned gold electrode could be repeated use throughout this study, but quantification of the reusability of the electrodes will be included in future work. Measured EOG signals are filtered and classified by a signal processing method, and kNN and CNN algorithms. Among them, the CNN-based classification shows the highest accuracy of 98.3% with six classes. Demonstration of wireless real-time control of a 2-wheeled RC car captures the performance of the wearable device for persistent HMI. Seven commands using eye movements successfully controled a car on a confined track while avoiding an obstacle. Future studies will address limitations, such as crosstalk between vertical and horizontal channels or EEG and EMG signals.

Fabrication. The study fabricated integrated wearable system. The wearable EOG device included a fractal gold electrode, headband-type platform, and flexible circuit. PDMS (Sylgard 184, Dow) was spin-coated on a clean glass slide. An 8.47 μm-thick polyimide shect (Kapton Film, DuPont) was laminated onto the PDMS-coated glass slide first. Followed by a 5 nm-thick Cr layer and 200 nm-thick Au layer that was deposited using an electron beam deposition tool (Denton Explorer), respectively. The study included open-mesh structured fractal patterns (a bending radius of 0.39 mm, and a trace width of 0.16 mm). The fractal pattern was cut by a femtosecond IR laser micromachining tool (WS-Flex, Optec), which is a multi-purpose, high-precision processing tool for various materials. The cut fractal pattern was transferred using water-soluble tape (ASWT-2, AQUASOL) from the PDMS. The wearable 3D headband platform was designed by SolidWorks and printed by a 3D printer (CUBICON Single Plus 3DP-310F) with thermoplastic polyurethane (TPU) filaments (CUBICON TPU Filament). TPU filaments are flexible with superior strength. The study designed the headband-type platform that can be resized according to the head size through the tension string and the auxiliary equipment as described with reference to FIG. 1F, above. Chip components on the flexible circuit were soldered to the plate with a solder paste (SMDLTLFP10T5, Chip Quik) and then heated at 100° C. The set temperature increased by 10° C. every minute to a final temperature of 150° C. A small lithium polymer battery (capacity: 40 mAh, Digi-Key) was modified to allow for casy charging by connecting two charging magnets and a switch to the battery. The circuit with a 40 mAh battery lasted 5.1 hours, which is around 8 mA power consumption [31]. The flexible circuit was attached to the back of the headband-type platform. The fractal gold electrodes were connected to the circuit via encapsulated ACF wires. Lastly, the electrodes were attached to the tension string.

Finite element analysis. The study conducted finite element analysis (FEA) to investigate a fractal gold electrode's mechanical behaviors using commercial software (ANSYS). This analysis focused on the mechanical fracture of the electrode upon cyclic bending and stretching. The modeling analyzed the maximum principal strain in the electrode consisting of three layers: an 8.47 μm-thick polyimide sheet, 5 nm-thick Cr layers, and 200 nm-thick Au layers (FIG. 12). One side of the substrate is fixed as a support fix and the other side is moved using the displacement function. The boundary conditions were applied to the Ecoflex TM substrate.

Experimental study of mechanical behavior. A customized stretcher conducted the axial stretching test. Two clamps held the sample. The strains were determined by controlling the distance from 0% to 30%. The bending test was conducted manually by a rigid circular cylinder. The bendability from 0° to 180° of the fractal gold electrodes was assessed manually with a bending radius of 6 mm (details in FIG. 13A). A digital multimeter is used to measure and record a resistance change on the fractal gold electrode.

Data acquisition and training. To detect EOG signals, two electrodes were positioned 1 cm above each eye. One electrode was placed 1 cm below the left lower eyelid for vertical eye movement. A common grounding electrode was placed on the middle of the forehead of a subject as shown in FIG. 13B. Before obtaining the data, the skin (electrode position) was optionally wiped with alcoholic cotton to remove foreign matter. The eyes were moved in six eye movements (left, right, up, down, blink, and null), and the gaze was within one second. The raw EOG signals from the wearable EOG device were measured and recorded by an Android tablet via Bluetooth. The custom android application simultaneously transmits and exports data for channels 1 and 2. As shown in FIG. 13C, MATLAB labeled the acquired EOG data to train the CNN classifier. And then, the EOG data was trained and modeled by a machine learning algorithm and TensorFlow platform. The modeled file, via MATLAB, classified the subject's EOG signals in real-time through the machine learning interface and TensorFlow platform in the android application.

Analysis of signal-to-noise ratio (SNR). The experiment was conducted by looking left and right three times at regular intervals for 5 seconds in this recording. The raw data were recorded into 5-second segments (5 total). This analysis involves measurement of EOG signal size and removal of the average value of the EOG signal using the following equation:

$$S N R ( dB ) = 10 {Log}_{10} ( \frac{RMS\_signal}{RMS\_noise} ) .$$

The results and the standard error were calculated as an average over the number of recordings.

### Example Computing Device

The methods described herein can be implemented using a computing device. It should be understood that the example computing device described herein is only one example of a suitable computing environment upon which the methods described herein may be implemented. Optionally, the computing device can be a well-known computing system including, but not limited to, personal computers, servers, handheld or laptop devices, multiprocessor systems, microprocessor-based systems, network personal computers (PCs), minicomputers, mainframe computers, embedded systems, and/or distributed computing environments including a plurality of any of the above systems or devices. Distributed computing environments enable remote computing devices, which are connected to a communication network or other data transmission medium, to perform various tasks. In the distributed computing environment, the program modules, applications, and other data may be stored on local and/or remote computer storage media.

In its most basic configuration, computing device typically includes at least one processing unit and system memory. Depending on the exact configuration and type of computing device, system memory may be volatile (such as random access memory (RAM), non-volatile (such as read-only memory (ROM), flash memory, etc.), or some combination of the two. The processing unit may be a standard programmable processor that performs arithmetic and logic operations necessary for the operation of the computing device. The computing device may also include a communication bus or other communication mechanism for communicating information among various components of the computing device.

Computing device may have additional features/functionality. For example, computing device may include additional storage such as removable storage and non-removable storage, including, but not limited to, magnetic or optical disks or tapes. Computing device may also contain network connection(s) that allow the device to communicate with other devices. Computing device may also have input and output means such as a keyboard, mouse, touch screen, a display, speakers, printer, etc. The additional devices may be connected to the communication bus in order to facilitate the communication of data among the components of the computing device. All these devices are well-known in the art and need not be discussed at length here.

The processing unit may be configured to execute program code encoded in tangible, computer-readable media. Tangible, computer-readable media refers to any media that is capable of providing data that causes the computing device (i.e., a machine) to operate in a particular fashion. Various computer-readable media may be utilized to provide instructions to the processing unit for execution. Example of tangible, computer-readable media may include, but is not limited to, volatile media, non-volatile media, removable media, and non-removable media implemented in any method or technology for storage of information such as computer-readable instructions, data structures, program modules or other data. System memory, removable storage, and non-removable storage are all examples of tangible, computer storage media. Examples of tangible, computer-readable recording media include, but are not limited to, an integrated circuit (e.g., field-programmable gate array or application-specific IC), a hard disk, an optical disk, a magneto-optical disk, a floppy disk, a magnetic tape, a holographic storage medium, a solid-state device, RAM, ROM, electrically erasable program read-only memory (EEPROM), flash memory or other memory technology, CD-ROM, digital versatile disks (DVD) or other optical storage, magnetic cassettes, magnetic tape, magnetic disk storage or other magnetic storage devices.

In an example implementation, the processing unit may execute program code stored in the system memory. For example, the communication bus may carry data to the system memory, from which the processing unit receives and executes instructions. The data received by the system memory may optionally be stored on the removable storage or the non-removable storage before or after execution by the processing unit.

It should be understood that the various techniques described herein may be implemented in connection with hardware or software or, where appropriate, with a combination thereof. Thus, the methods and apparatuses of the presently disclosed subject matter, or certain aspects or portions thereof, may take the form of program code (i.e., instructions) embodied in tangible media, such as floppy diskettes, CD-ROMs, hard drives, or any other machine-readable storage medium where, when the program code is loaded into and executed by a machine, such as a computing device, the machine becomes an apparatus for practicing the presently disclosed subject matter. In the case of program code execution on programmable computers, the computing device generally includes a processor, a storage medium readable by the processor (including volatile and non-volatile memory and/or storage elements), at least one input device, and at least one output device. One or more programs may implement or utilize the processes described in connection with the presently disclosed subject matter, e.g., through the use of an application programming interface (API), reusable controls, or the like. Such programs may be implemented in a high-level procedural or object-oriented programming language to communicate with a computer system. However, the program(s) can be implemented in assembly or machine language, if desired. In any case, the language may be a compiled or interpreted language, and it may be combined with hardware implementations.

It should be appreciated that the logical operations described above and, in the appendix, can be implemented (1) as a sequence of computer-implemented acts or program modules running on a computing system and/or (2) as interconnected machine logic circuits or circuit modules within the computing system. The implementation is a matter of choice dependent on the performance and other requirements of the computing system. Accordingly, the logical operations described herein are referred to variously as state operations, acts, or modules. These operations, acts and/or modules can be implemented in software, in firmware, in special purpose digital logic, in hardware, and any combination thereof. It should also be appreciated that more or fewer operations can be performed than shown in the figures and described herein. These operations can also be performed in a different order than those described herein.

Machine Learning. In addition to the machine learning features described above, the various analysis system can be implemented using one or more artificial intelligence and machine learning operations. The term “artificial intelligence” can include any technique that enables one or more computing devices or comping systems (i.e., a machine) to mimic human intelligence. Artificial intelligence (AI) includes but is not limited to knowledge bases, machine learning, representation learning, and deep learning. The term “machine learning” is defined herein to be a subset of AI that enables a machine to acquire knowledge by extracting patterns from raw data. Machine learning techniques include, but are not limited to, logistic regression, support vector machines (SVMs), decision trees, Naïve Bayes classifiers, and artificial neural networks. The term “representation learning” is defined herein to be a subset of machine learning that enables a machine to automatically discover representations needed for feature detection, prediction, or classification from raw data. Representation learning techniques include, but are not limited to, autoencoders and embeddings. The term “deep learning” is defined herein to be a subset of machine learning that enables a machine to automatically discover representations needed for feature detection, prediction, classification, etc., using layers of processing. Deep learning techniques include but are not limited to artificial neural networks or multilayer perceptron (MLP).

Machine learning models include supervised, semi-supervised, and unsupervised learning models. In a supervised learning model, the model learns a function that maps an input (also known as feature or features) to an output (also known as target) during training with a labeled data set (or dataset). In an unsupervised learning model, the algorithm discovers patterns among data. In a semi-supervised model, the model learns a function that maps an input (also known as a feature or features) to an output (also known as a target) during training with both labeled and unlabeled data.

Neural Networks. An artificial neural network (ANN) is a computing system including a plurality of interconnected neurons (e.g., also referred to as “nodes”). This disclosure contemplates that the nodes can be implemented using a computing device (e.g., a processing unit and memory as described herein). The nodes can be arranged in a plurality of layers such as an input layer, an output layer, and optionally one or more hidden layers with different activation functions. An ANN having hidden layers can be referred to as a deep neural network or multilayer perceptron (MLP). Each node is connected to one or more other nodes in the ANN. For example, each layer is made of a plurality of nodes, where each node is connected to all nodes in the previous layer. The nodes in a given layer are not interconnected with one another, i.e., the nodes in a given layer function independently of one another. As used herein, nodes in the input layer receive data from outside of the ANN, nodes in the hidden layer(s) modify the data between the input and output layers, and nodes in the output layer provide the results. Each node is configured to receive an input, implement an activation function (e.g., binary step, linear, sigmoid, tanh, or rectified linear unit (ReLU), and provide an output in accordance with the activation function. Additionally, each node is associated with a respective weight. ANNs are trained with a dataset to maximize or minimize an objective function. In some implementations, the objective function is a cost function, which is a measure of the ANN's performance (e.g., error such as L1 or L2 loss) during training, and the training algorithm tunes the node weights and/or bias to minimize the cost function. This disclosure contemplates that any algorithm that finds the maximum or minimum of the objective function can be used for training the ANN. Training algorithms for ANNs include but are not limited to backpropagation. It should be understood that an ANN is provided only as an example machine learning model. This disclosure contemplates that the machine learning model can be any supervised learning model, semi-supervised learning model, or unsupervised learning model. Optionally, the machine learning model is a deep learning model. Machine learning models are known in the art and are therefore not described in further detail herein.

A convolutional neural network (CNN) is a type of deep neural network that has been applied, for example, to image analysis applications. Unlike traditional neural networks, each layer in a CNN has a plurality of nodes arranged in three dimensions (width, height, depth). CNNs can include different types of layers, e.g., convolutional, pooling, and fully-connected (also referred to herein as “dense”) layers. A convolutional layer includes a set of filters and performs the bulk of the computations. A pooling layer is optionally inserted between convolutional layers to reduce the computational power and/or control overfitting (e.g., by downsampling). A fully-connected layer includes neurons, where each neuron is connected to all of the neurons in the previous layer. The layers are stacked similar to traditional neural networks. GCNNs are CNNs that have been adapted to work on structured datasets such as graphs.

Other Supervised Learning Models. A logistic regression (LR) classifier is a supervised classification model that uses the logistic function to predict the probability of a target, which can be used for classification. LR classifiers are trained with a data set (also referred to herein as a “dataset”) to maximize or minimize an objective function, for example, a measure of the LR classifier's performance (e.g., error such as L1 or L2 loss), during training. This disclosure contemplates that any algorithm that finds the minimum of the cost function can be used. LR classifiers are known in the art and are therefore not described in further detail herein.

A Naïve Bayes' (NB) classifier is a supervised classification model that is based on Bayes' Theorem, which assumes independence among features (i.e., the presence of one feature in a class is unrelated to the presence of any other features). NB classifiers are trained with a data set by computing the conditional probability distribution of each feature given a label and applying Bayes' Theorem to compute the conditional probability distribution of a label given an observation. NB classifiers are known in the art and are therefore not described in further detail herein.

A k-NN classifier is an unsupervised classification model that classifies new data points based on similarity measures (e.g., distance functions). The k-NN classifiers are trained with a data set (also referred to herein as a “dataset”) to maximize or minimize a measure of the k-NN classifier's performance during training. This disclosure contemplates any algorithm that finds the maximum or minimum. The k-NN classifiers are known in the art and are therefore not described in further detail herein.

Although example embodiments of the present disclosure are explained in some instances in detail herein, it is to be understood that other embodiments are contemplated. Accordingly, it is not intended that the present disclosure be limited in its scope to the details of construction and arrangement of components set forth in the following description or illustrated in the drawings. The present disclosure is capable of other embodiments and of being practiced or carried out in various ways.

It must also be noted that, as used in the specification and the appended claims, the singular forms “a,” “an” and “the” include plural referents unless the context clearly dictates otherwise. Ranges may be expressed herein as from “about” or “5 approximately” one particular value and/or to “about” or “approximately” another particular value. When such a range is expressed, other exemplary embodiments include from the one particular value and/or to the other particular value.

By “comprising” or “containing” or “including” is meant that at least the name compound, element, particle, or method step is present in the composition or article or method, but does not exclude the presence of other compounds, materials, particles, method steps, even if the other such compounds, material, particles, method steps have the same function as what is named.

In describing example embodiments, terminology will be resorted to for the sake of clarity. It is intended that each term contemplates its broadest meaning as understood by those skilled in the art and includes all technical equivalents that operate in a similar manner to accomplish a similar purpose. It is also to be understood that the mention of one or more steps of a method does not preclude the presence of additional method steps or intervening method steps between those steps expressly identified. Steps of a method may be performed in a different order than those described herein without departing from the scope of the present disclosure. Similarly, it is also to be understood that the mention of one or more components in a device or system does not preclude the presence of additional components or intervening components between those components expressly identified.

As discussed herein, a “subject” may be any applicable human, animal, or other organism, living or dead, or other biological or molecular structure or chemical environment, and may relate to particular components of the subject, for instance specific tissues or fluids of a subject (e.g., human tissue in a particular area of the body of a living subject), which may be in a particular location of the subject, referred to herein as an “area of interest” or a “region of interest.”

It should be appreciated that as discussed herein, a subject may be a human or any animal. It should be appreciated that an animal may be a variety of any applicable type, including, but not limited thereto, mammal, veterinarian animal, livestock animal or pet type animal, etc. As an example, the animal may be a laboratory animal specifically selected to have certain characteristics similar to human (e.g. rat, dog, pig, monkey), etc. It should be appreciated that the subject may be any applicable human patient, for example.

The term “about,” as used herein, means approximately, in the region of, roughly, or around. When the term “about” is used in conjunction with a numerical range, it modifies that range by extending the boundaries above and below the numerical values set forth. In general, the term “about” is used herein to modify a numerical value above and below the stated value by a variance of 10%. In one aspect, the term “about” means plus or minus 10% of the numerical value of the number with which it is being used. Therefore, about 50% means in the range of 45%-55%. Numerical ranges recited herein by endpoints include all numbers and fractions subsumed within that range (e.g., 1 to 5 includes 1, 1.5, 2, 2.75, 3, 3.90, 4, 4.24, and 5).

Similarly, numerical ranges recited herein by endpoints include subranges subsumed within that range (e.g., 1 to 5 includes 1-1.5, 1.5-2, 2-2.75, 2.75-3, 3-3.90, 3.90-4, 4-4.24, 4.24-5, 2-5, 3-5, 1-4, and 2-4). It is also to be understood that all numbers and fractions thereof are presumed to be modified by the term “about.”

The following patents, applications and publications as listed below and throughout this document are hereby incorporated by reference in their entirety herein.
[1] Kartsch, V.; Guermandi, M.; Benatti, S.; Montagna, F.; Benini, L. An Energy-Efficient IoT node for HMI applications based on an ultra-low power Multicore Processor. In 2019 IEEE Sensors Applications Symposium (SAS), 2019; IEEE: pp 1-6.
[2] Kaur, A. Wheelchair control for disabled patients using EMG/EOG based human machine interface: a review. J Med Eng Technol 2021, 45 (1), 61-74. DOI: 10.1080/03091902.2020.1853838.
[3] Bulling, A.; Roggen, D.; Tröster, G. Wearable EOG goggles: Seamless sensing and context-awareness in everyday environments. Journal of Ambient Intelligence and Smart Environments 2009, 1 (2), 157-171.
[4] Mala, S.; Latha, K. Feature selection in classification of eye movements using electrooculography for activity recognition. Comput Math Methods Med 2014, 2014, 713818. DOI: 10.1155/2014/713818.
[5] Bulling, A.; Ward, J. A.; Gellersen, H.; Tröster, G. Eye movement analysis for activity recognition using electrooculography. IEEE transactions on pattern analysis and machine intelligence 2010, 33 (4), 741-753.
[6] Poon, C. C.; Leung, E. Y.; Lau, K. C.; Leung, B. H.; Zheng, Y. L.; Chiu, P. W.; Yam, Y. A novel user-specific wearable controller for surgical robots. In International Conference of Design, User Experience, and Usability, 2015; Springer: pp 693-701.
[7] Gray, V.; Rice, C. L.; Garland, S. J. Factors that influence muscle weakness following stroke and their clinical implications: a critical review. Physiotherapy Canada 2012, 64 (4), 415-426.
[8] Lum, P. S.; Godfrey, S. B.; Brokaw, E. B.; Holley, R. J.; Nichols, D. Robotic approaches for rehabilitation of hand function after stroke. American journal of physical medicine & rehabilitation 2012, 91 (11), S242-S254.
[9] Xiao, R.; Ding, L. Evaluation of EEG features in decoding individual finger movements from one hand. Computational and mathematical methods in medicine 2013, 2013.
[10] Dey, N. Classification and clustering in biomedical signal processing; IGI global, 2016.
[11] Siddiqui, U.; Shaikh, A. An overview of electrooculography. International Journal of Advanced Research in Computer and Communication Engineering 2013, 2 (11), 4328-4330.
[12] Ameri, S. K.; Kim, M.; Kuang, I. A.; Perera, W. K.; Alshiekh, M.; Jeong, H.; Topcu, U.; Akinwande, D.; Lu, N. Imperceptible electrooculography graphene sensor system for human-robot interface. npj 2D Materials and Applications 2018, 2 (1), 1-7.
[13] Park, S.; Kim, H.; Kim, J.-H.; Yeo, W.-H. Advanced nanomaterials, printing processes, and applications for flexible hybrid electronics. Materials 2020, 13 (16), 3587.
[14] Mishra, S.; Norton, J. J. S.; Lee, Y.; Lec, D. S.; Agee, N.; Chen, Y.; Chun, Y.; Yeo, W. H. Soft, conformal bioelectronics for a wireless human-wheelchair interface. Biosens Bioelectron 2017, 91, 796-803. DOI: 10.1016/j.bios.2017.01.044.
[15] Aziz, F.; Arof, H.; Mokhtar, N.; Mubin, M. HMM based automated wheelchair navigation using EOG traces in EEG. J Neural Eng 2014, 11 (5), 056018. DOI: 10.1088/1741-2560/11/5/056018.
[16] Barca, R.; Boquete, L.; Mazo, M.; López, E. System for assisted mobility using eye movements based on electrooculography. IEEE Trans Neural Syst Rehabil Eng 2002, 10 (4), 209-218. DOI: 10.1109/TNSRE.2002.806829.
[17] Belkacem, A. N.; Shin, D.; Kambara, H.; Yoshimura, N.; Koike, Y. Online classification algorithm for eye-movement-based communication systems using two temporal EEG sensors. Biomedical Signal Processing and Control 2015, 16, 40-47.
[18] Wu, S.-L.; Liao, L.-D.; Lu, S.-W.; Jiang, W.-L.; Chen, S.-A.; Lin, C.-T. Controlling a human-computer interface system with a novel classification method that uses electrooculography signals. IEEE transactions on Biomedical Engineering 2013, 60 (8), 2133-2141.
[19] Ban, S.; Lec, Y. J.; Kim, K. R.; Kim, J.-H.; Yco, W.-H. Advances in Materials, Sensors, and Integrated Systems for Monitoring Eye Movements. Biosensors 2022, 12 (11), 1039.
[20] Dhuliawala, M.; Lec, J.; Shimizu, J.; Bulling, A.; Kunze, K.; Starner, T.; Woo, W. Smooth eye movement interaction using EOG glasses. In Proceedings of the 18th ACM International Conference on Multimodal Interaction, 2016; pp 307-311.
[21] Lee, J. H.; Kim, H.; Hwang, J.-Y.; Chung, J.; Jang, T.-M.; Seo, D. G.; Gao, Y.; Lee, J.; Park, H.; Lee, S. 3D printed, customizable, and multifunctional smart electronic eyeglasses for wearable healthcare systems and human-machine Interfaces. ACS Applied Materials & Interfaces 2020, 12 (19), 21424-21432.
[22] Kim, Y. S.; Mahmood, M.; Lee, Y.; Kim, N. K.; Kwon, S.; Herbert, R.; Kim, D.; Cho, H. C.; Yeo, W. H. All-in-one, wireless, stretchable hybrid electronics for smart, connected, and ambulatory physiological monitoring. Advanced Science 2019, 6 (17), 1900939.
[23] Golparvar, A. J.; Yapici, M. K. Graphene smart textile-based wearable eye movement sensor for electro-ocular control and interaction with objects. Journal Of the Electrochemical Society 2019, 166 (9), B3184.
[24] Yaramothu, C.; Vito d′Antonio-Bertagnolli, J.; Santos, E. M.; Crincoli, P. C.; Rajah, J. V.; Scheiman, M.; Alvarez, T. L. Proceedings #37: Virtual Eye Rotation Vision Exercises (VERVE): A Virtual Reality Vision Therapy Platform with Eye Tracking. Brain Stimulation 2019, 12 (2), e107-e108. DOI: https://doi.org/10.1016/j.brs.2018.12.206.
[25] Mishra, S.; Kim, Y.-S.; Intarasirisawat, J.; Kwon, Y.-T.; Lee, Y.; Mahmood, M.; Lim, H.-R.; Herbert, R.; Yu, K. J.; Ang, C. S. Soft, wireless periocular wearable electronics for real-time detection of eye vergence in a virtual reality toward mobile eye therapies. Science advances 2020, 6 (11), eaay 1729.
[26] Yu, K. J.; Kim, T.; Shin, Y.; Kang, K.; Kim, K.; Kim, G.; Byeon, Y.; Kim, H.; Gao, Y.; Kim, J. Ultra-thin crystalline silicon-based strain gauges with deep learning algorithms for silent speech interfaces. 2022, 13, 5815.
[27] Sang, M.; Kang, K.; Zhang, Y.; Zhang, H.; Kim, K.; Cho, M.; Shin, J.; Hong, J. H.; Kim, T.; Lee, S. K. Ultrahigh Sensitive Au-Doped Silicon Nanomembrane Based Wearable Sensor Arrays for Continuous Skin Temperature Monitoring with High Precision. Advanced Materials 2022, 34 (4), 2105865.
[28] Heo, J.; Yoon, H.; Park, K. S. A novel wearable forehead EOG measurement system for human computer interfaces. Sensors 2017, 17 (7), 1485.
[39] Lopez, A.; Ferrero, F. J.; Valledor, M.; Campo, J. C.; Postolache, O. A study on electrode placement in EOG systems for medical applications. In 2016 IEEE International symposium on medical measurements and applications (MeMeA), 2016; IEEE: pp 1-5.
[30] Zhang, Y.-F.; Gao, X.-Y.; Zhu, J.-Y.; Zheng, W.-L.; Lu, B.-L. A novel approach to driving fatigue detection using forehead EOG. In 2015 7th International IEEE/EMBS Conference on Neural Engineering (NER), 2015; IEEE: pp 707-710.
[31] Mahmood, M.; Kwon, S.; Berkmen, G. K.; Kim, Y.-S.; Scorr, L.; Jinnah, H.; Yco, W.-H. Soft nanomembrane sensors and flexible hybrid bioelectronics for wireless quantification of blepharospasm. IEEE Transactions on Biomedical Engineering 2020, 67 (11), 3094-3100.
[32] Kim, J.; Salvatore, G. A.; Araki, H.; Chiarelli, A. M.; Xic, Z.; Banks, A.; Sheng, X.; Liu, Y.; Lec, J. W.; Jang, K.-I. Battery-free, stretchable optoelectronic systems for wireless optical characterization of the skin. Science advances 2016, 2 (8), e1600418.
[33] Kim, Y. S.; Lu, J.; Shih, B.; Gharibans, A.; Zou, Z.; Matsuno, K.; Aguilera, R.; Han, Y.; Meck, A.; Xiao, J. Scalable manufacturing of solderable and stretchable physiologic sensing systems. Advanced Materials 2017, 29 (39), 1701312.
[34] Lec, S. P.; Ha, G.; Wright, D. E.; Ma, Y.; Sen-Gupta, E.; Haubrich, N. R.; Branche, P. C.; Li, W.; Huppert, G. L.; Johnson, M. Highly flexible, wearable, and disposable cardiac biosensors for remote and ambulatory monitoring. NPJ digital medicine 2018, 1 (1), 1-8.
[35] Kim, Y.-S.; Basir, A.; Herbert, R.; Kim, J.; Yoo, H.; Yeo, W.-H. Soft materials, stretchable mechanics, and optimized designs for body-wearable compliant antennas. ACS Applied Materials & Interfaces 2019, 12 (2), 3059-3067.
[36] Yeo, W. H.; Kim, Y. S.; Lec, J.; Ameen, A.; Shi, L.; Li, M.; Wang, S.; Ma, R.; Jin, S. H.; Kang, Z. Multifunctional epidermal electronics printed directly onto the skin. Advanced materials 2013, 25 (20), 2773-2778.
[37] Hattori, Y.; Falgout, L.; Lec, W.; Jung, S. Y.; Poon, E.; Lec, J. W.; Na, I.; Geisler, A.; Sadhwani, D.; Zhang, Y. Multifunctional skin-like electronics for quantitative, clinical monitoring of cutaneous wound healing. Advanced healthcare materials 2014, 3 (10), 1597-1607.
[38] Merino, M.; Rivera, O.; Gómez, I.; Molina, A.; Dorronzoro, E. A method of EOG signal processing to detect the direction of eye movements. In 2010 First International Conference on Sensor Device Technologies and Applications, 2010; IEEE: pp 100-105.
[39] Qiu, H.; Guo, Z.; Zhang, X. The design of FIR band-pass filter with improved distributed algorithm based on FPGA. In 2010 International Conference on Multimedia Technology, 2010; IEEE: pp 1-4.
[40] Hayawi, A. A.; Waleed, J. Driver's drowsiness monitoring and alarming auto-system based on EOG signals. In 2019 2nd International Conference on Engineering Technology and its Applications (IICETA), 2019; IEEE: pp 214-218.
[41] Syal, P.; Kumari, P. Comparative Analysis of KNN, SVM, DT for EOG based Human Computer Interface. In 2017 International Conference on Current Trends in Computer, Electrical, Electronics and Communication (CTCEEC), 2017; IEEE: pp 1023-1028.
[42] Mustafa, M.; Taib, M.; Murat, Z.; Sulaiman, N. Comparison between KNN and ANN classification in brain balancing application via spectrogram image. Journal of Computer Science & Computational Mathematics 2012, 2 (4), 17-22.
[43] Golparvar, A. J.; Yapici, M. K. Toward graphene textiles in wearable eye tracking systems for human-machine interaction. Beilstein Journal of Nanotechnology 2021, 12 (1), 180-189.
[44] Vourvopoulos, A.; Niforatos, E.; Giannakos, M. EEGlass: An EEG-cyeware prototype for ubiquitous brain-computer interaction. In Adjunct proceedings of the 2019 ACM international joint conference on pervasive and ubiquitous computing and proceedings of the 2019 ACM international symposium on wearable computers, 2019; pp 647-652.
[45] Tabal, K. M.; Cruz, J. D. Development of low-cost embedded-based electrooculogram blink pulse classifier for drowsiness detection system. In 2017 IEEE 13th International Colloquium on Signal Processing & its Applications (CSPA), 2017; IEEE: pp 29-34.
[46] Vehkaoja, A. T.; Verho, J. A.; Puurtinen, M. M.; Nojd, N. M.; Lekkala, J. O.; Hyttinen, J. A. Wireless head cap for EOG and facial EMG measurements. In 2005 IEEE Engineering in Medicine and Biology 27th Annual Conference, 2006; IEEE: pp 5865-5868.
[47] Pérez-Reynoso, F. D.; Rodríguez-Guerrero, L.; Salgado-Ramírez, J. C.; Ortega-Palacios, R. Human-Machine Interface: Multiclass Classification by Machine Learning on ID EOG Signals for the Control of an Omnidirectional Robot. Sensors 2021, 21 (17), 5882.
[48] López, A.; Fernández, M.; Rodríguez, H.; Ferrero, F.; Postolache, O. Development of an EOG-based system to control a serious game. Measurement 2018, 127, 481-488.
[49] O'Bard, B.; Larson, A.; Herrera, J.; Nega, D.; George, K. Electrooculography based iOS controller for individuals with quadriplegia or neurodegenerative disease. In 2017 IEEE International Conference on Healthcare Informatics (ICHI), 2017; IEEE: pp 101-106.

What is claimed:

1. A system comprising:
a set of electrooculogram (EOG) sensors, each comprising an array of flexible electrodes fabricated on a flexible-circuit substrate, the flexible-circuit substrate comprising an analog-to-digital converter circuitry operatively connected to a wireless interface circuitry; and
a brain-machine interface operatively connected to the set of EOG sensors, the brain-machine interface comprising:
a processor; and a memory operatively connected to the processor, the memory having instructions stored thereon, wherein execution of the instructions by the processor causes the processor to:
receive EOG signals acquired from the EOG sensors;
continuously classify brain signals as control signals via a trained AI model from the acquired EOG signals; and
output the control signals.

2. The system of claim 1, wherein the EOG sensor is a low-profile EOG sensor.

3. The system of claim 1, wherein each array of flexible electrodes comprises fractal patterned electrodes.

4. The system of claim 3, wherein the fractal patterned electrodes comprise a plurality of curved electrodes.

5. The system of claim 1, wherein each array of flexible electrodes comprises electrodes patterned in an open-mesh.

6. The system of claim 1, wherein the array of flexible electrodes comprise a polyimide sheet, a chromium layer, and a gold layer.

7. The system of claim 1, wherein the wireless interface circuitry comprises a flexible circuit.

8. The system of claim 1, further comprising a headband, wherein the flexible-circuit substrate is coupled to the headband and the headband is configured to dispose the set of EOG sensors on a skin surface of a wearer.

9. The system of claim 8, wherein the headband comprises flexible thermoplastic.

10. The system of claim 1, wherein the controller is a vehicle controller, and wherein the control signals are configured to control a vehicle.

11. The system of claim 1, wherein the controller is a healthcare system controller and wherein the control signals are configured to control a healthcare system.

12. The system of claim 1, wherein the trained neural network comprises a convolutional neural network (CNN) classifier.

13. The system of claim 1, wherein the electrodes comprise nanomembrane electrodes.

14. The system of claim 1, wherein the electrodes comprise dry gold electrodes.

15. A method comprising:
providing a set of EOG sensors placed at a scalp of a user, wherein each EOG sensor of the set of EOG sensors comprises an array of flexible electrodes fabricated on a flexible circuit substrate, the flexible circuit substrate operatively connected to an analog-to-digital converter circuitry operatively coupled to a wireless interface circuitry; and
receiving, by a processor or a brain-machine interface operatively connected to the set of EOG sensors, EOG signals acquired from the EOG sensor
continuously classifying, by the processor, brain signals as control signals via a trained neural network from the acquired EOG signals; and
outputting, by the processor, the control signals.

16. The method of claim 15, wherein the method further comprises controlling a vehicle based on the control signals.

17. The method of claim 15, wherein the trained neural network comprises a CNN classifier.

18. A non-transitory computer-readable medium having instructions stored thereon, wherein execution of the instructions by a processor of a brain-machine interface controller causes the processor to:
receive EOG signals from a set of EOG sensors placed at a scalp of a user, wherein each EOG sensor of the set of EOG sensors comprises an array of flexible electrodes fabricated on a flexible circuit substrate, the flexible circuit substrate operatively connected to an analog-to-digital converter circuitry operatively coupled to a wireless interface circuitry;
continuously classify brain signals as control signals via a trained AI model from the EOG signals; and
output the control signals.

19. The computer-readable medium of claim 18, further comprising instructions to control a vehicle based on the control signals.

20. The computer-readable medium of claim 18, wherein the trained neural network comprises a CNN classifier.
